(19) United States
(12) Patent Application Publication
(10) Pub. No.: US 2025/0264694 A1
(43) Pub. Date: Aug. 21, 2025

(54) OPTICAL SYSTEM AND CAMERA MODULE INCLUDING SAME

(71) Applicant: LG INNOTEK CO., LTD., Seoul (KR)

(72) Inventor: Doo Shik SIN, Seoul (KR)

(73) Assignee: LG INNOTEK CO., LTD., Seoul (KR)

(21) Appl. No.: 18/867,342

(22) PCT Filed: May 22, 2023
(86) PCT No.: PCT/KR2023/006940

§ 371 Date: Nov. 19, 2024

(30) Foreign Application Priority Data
May 20, 2022 (KR) 10-2022-0062224

(51) Int. Cl. G02B 13/00; G03B 30/00; H04N 23/55

(52) U.S. Cl. CPC G02B 13/0045; G03B 30/00; H04N 23/55

(57) ABSTRACT

The optical system disclosed in the embodiment of the invention includes first to eighth lenses disposed along an optical axis in a direction from an object side to a sensor side, wherein the first lens has a positive (+) refractive power on the optical axis and has a meniscus shape that is convex toward the object side, the eighth lens has a negative (−) refractive power on the optical axis and has a meniscus shape that is convex toward the object side, an object-side surface of the seventh lens has a critical point, a sensor-side surface of the eight lens has a critical point, an effective diameter of a sensor-side surface of the third lens is CA_L3S2, an effective diameter of an object-side surface of the fourth lens is CA_L4S1, a maximum thickness among center thicknesses of the first to eighth lenses is CT_Max, and a maximum distance among distances between the first to eighth lenses is CG_Max, and the following Equations may satisfy: 0.5<CA_L3S2/CA_L4S1<1.5 and 0<CT_Max/CG_Max<1.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions.

For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for the camera module to obtain an image is an imaging lens that forms an image, Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted.

However, when a plurality of lenses is included, there is a problem in that it is difficult to derive excellent optical properties and aberration properties. In addition, when a plurality of lenses is included, the overall length, height, etc. may increase due to the thickness, interval, size, etc. of the plurality of lenses, thereby increasing the overall size of the module including the plurality of lenses.

In addition, the size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system. Therefore, a new optical system capable of solving the above problems is required.

### DISCLOSURE

### Technical Problem

An embodiment of the invention provides an optical system with improved optical properties. An embodiment provides an optical system having excellent optical performance at the center and periphery portions of the field of view. An embodiment provides an optical system capable of having a slim structure.

### Technical Solution

An optical system according to an embodiment of the invention comprises first to eighth lenses disposed along an optical axis in a direction from an object side to a sensor side, wherein the first lens has a positive (±) refractive power on the optical axis and has a meniscus shape that is convex toward the object side, the eighth lens has a negative (−) refractive power on the optical axis and has a meniscus shape that is convex toward the object side, an object-side surface of the seventh lens has a critical point, a sensor-side surface of the eight lens has a critical point, an effective diameter of a sensor-side surface of the third lens is CA_L3S2, an effective diameter of an object-side surface of the fourth lens is CA_L4S1, a maximum thickness among center thicknesses of the first to eighth lenses is CT_Max, and a maximum distance among distances between the first to eighth lenses is CG_Max, and the following Equations may satisfy: 0.5<CA_L3S2/CA_L4S1<1.5 and 0<CT_Max/CG_Max<1.

According to an embodiment of the invention, each of a sensor-side surface of the seventh lens and an object-side surface of the eighth lens has a critical point, and the critical point of the object-side surface of the eighth lens may be located closer to the optical axis than the critical points of the object-side surface and the object-side surface of the seventh lens.

According to an embodiment of the invention, an optical axis distance from a center of an object-side surface of the first lens to a surface of an image sensor is TTL, ½ of a maximum diagonal length of the image sensor is Imgh, a field of view of the optical system is FOV, and the following Equations may satisfy: 5<(TTL/Imgh)*n<15 and (TTL*n)<FOV, where n may be a total number of lenses.

According to an embodiment of the invention, when an entrance pupil diameter of the optical system is EPD and a curvature radius of the object-side surface of the first lens on the optical axis is L1R1, the following Equation may satisfy: 1<EPD/L1R1<2.

According to an embodiment of the invention, the following Equations may satisfy: Imgh<TTL and 50<TTL*Imgh<90 (An optical axis distance from the center of the object-side surface of the first lens to the surface of the image sensor is TTL, and ½ of the maximum diagonal length of the image sensor is Imgh.).

According to an embodiment of the invention, a normal line perpendicular to a tangent line passing through an arbitrary point on the sensor-side surface of the eighth lens has a maximum first angle with respect to the optical axis, and the first angle may satisfy in a range of 20 degrees to 40 degrees.

According to an embodiment of the invention, a normal line perpendicular to a tangent line passing through an arbitrary point on the object-side surface of the eighth lens has a maximum second angle with respect to the optical axis, and a difference between the first angle and the second angle may be less than 10 degrees.

According to an embodiment of the invention, a normal line perpendicular to a tangent line passing through an arbitrary point on the sensor-side surface of the seventh lens has a maximum third angle with respect to the optical axis, and a difference between the first angle and the third angle may be less than 10 degrees.

According to an embodiment of the invention, a normal line perpendicular to a tangent line passing through an arbitrary point on the object-side surface of the seventh lens has a maximum fourth angle with respect to the optical axis, and a difference between the first angle and the fourth angle may be less than 10 degrees.

According to an embodiment of the invention, the second, third, and seventh lenses may have a meniscus shape that is convex toward the object side on the optical axis.

According to an embodiment of the invention, a maximum of effective diameters of the object-side surface and the sensor-side surface of each of the first to eighth lenses is CA_Max, ½ of the maximum diagonal length of the image sensor is Imgh, and the following Equation may satisfy: 0.1<CA_max/(2*ImgH)<1.

According to an embodiment of the invention, the following Equation may satisfy: (v3*n3)<(v1*n1) (v1 is an Abbe number of the first lens, v3 is an Abbe number of the third lens, n1 is a refractive index of the first lens, and n3 is a refractive index of the third lens.).

An optical system according to an embodiment of the invention includes a first lens group having a plurality of lenses disposed on an object side; a second lens group having a plurality of lenses disposed on a sensor side of the first lens group; and an aperture stop disposed around an object-side surface of any one of the lenses of the first lens group, wherein each of the lenses of the first lens group has a. meniscus shape convex toward the object side on an optical axis, last n-th and n-th lenses among the lenses of the second lens group have a meniscus shape convex toward the object side on the optical axis, the first lens group has a positive refractive power, the second lens group has a negative refractive power, a number of the lenses of the second lens group is greater than a number of the lenses of the first lens group, and the following Equation may satisfy: 40<(FOV*TTL)/n<150 (TTL is an optical axis distance from a center of an object-side surface of a first lens to a surface of the image sensor, n is a total number of lenses, and FOV is field of view.).

According to an embodiment of the invention, effective diameters of the lenses of the first lens group gradually decreases from the object side toward the sensor side, and effective diameters of the lenses of the second lens group may gradually increase from a lens surface closest to the first lens group toward the image sensor.

According to an embodiment of the invention, a focal length of the first lens group is F13, a focal length of the second lens group is F48, and the following equation may satisfy: 1<|F48/F13|<4 (F48<0).

According to an embodiment of the invention, the first lens group includes first to third lenses, the second lens group includes fourth to eighth lenses, and the aperture stop is disposed around an object-side surface of the second lens, and the following Equation may satisfy: CT6+CT7+CT8<CG7 (CT6 is a center thickness of the sixth lens, CT7 is a center thickness of the seventh lens, CT8 is a center thickness of the eighth lens, and CG7 is a center distance between the seventh and eighth lenses.).

According to an embodiment of the invention, an object-side surface and a sensor-side surface of the seventh lens may have a critical point, and an object-side surface and a sensor-side surface of the eighth lens may have a critical point.

According to an embodiment of the invention, a difference between an angle between the optical axis and a normal line perpendicular to a tangent line passing through an arbitrary point of the object-side surface of the seventh lens and an angle between the optical axis and a normal line perpendicular to a tangent line passing through an arbitrary point of the object-side surface of the eighth lens may be less than 10 degrees.

According to an embodiment of the invention, a difference between an angle between the optical axis and a normal line perpendicular to a tangent line passing through an arbitrary point of the sensor-side surface of the seventh lens and an angle between the optical axis and a normal line perpendicular to a tangent line passing through an arbitrary point of the sensor-side surface of the eighth lens may be less than 10 degrees.

According to an embodiment of the invention, the following equation nay satisfy: 100<|L5R2/CT5|<300 (L5R2 is a curvature radius of the fifth lens on the optical axis, and CT5 is a center thickness of the fifth lens.).

According to an embodiment of the invention, the following equations may satisfy: 0<CT6/CG7<2, 2<CG6/CT6<9, and 1<CG7/CT7<5 (CT6 is a center thickness of the sixth lens, CT7 is a center thickness of the seventh lens, CG6 is a center distance between the sixth and seventh lenses, and CG7 is a center distance between the seventh and eighth lenses.).

According to an embodiment of the invention, a sum ΣCT of center thicknesses of the lenses of the first and second lens groups and sum ΣCG of distances between two adjacent lenses may satisfy the following equation: 0<ΣCT/ΣCG<1.

A camera module according to an embodiment of the invention includes an image sensor disposed on a sensor side of a plurality of lenses; and an optical filter disposed between the image sensor and a last lens, wherein an optical system includes a optical system disclosed above, and the following equations may satisfy: 0.5<F/TTL<1.5, 0.5<TTL/ImgH 3, and 4≤Imgh K TTL (F is a total focal length, TTL is a distance in the optical axis from a center of an object-side surface of a lens closest to the object side to an image surface of the image sensor, and Imgh is ½ of a maximum diagonal length of the image sensor.).

### Advantageous Effects

The optical system and the camera module according to the embodiment may have improved optical properties. In detail, the optical system may have improved aberration characteristics and resolving power according to the surface shape, refractive power, thickness of a plurality of lenses and distance between adjacent lenses of a plurality of lenses.

The optical system and the camera module according to the embodiment may have improved distortion and aberration characteristics, and may have good optical performance at the center and periphery portions of the field of view (FOV).

The optical system according to the embodiment may have improved optic-al characteristics and a small total track length (TTL), so that the optical system and a camera module including the same may be provided in a slim and compact structure.

### DESCRIPTION OF DRAWINGS

FIG. 1 is a configuration diagram of an optical system and a camera module according to an embodiment of the invention.

FIG. 2 is an explanatory diagram illustrating the relationship between an image sensor, an n-th lens, and an n-1th lens of the optical system of FIG. 1.

FIG. 3 is a table showing lens data according to the embodiment having the optical system of FIG. 1.

FIG. 4 is an example of aspherical surface coefficients of lenses according to the embodiment of the invention.

FIG. 5 is a table showing thicknesses of lenses and intervals between lenses according to a direction orthogonal to an optical axis in the optical system according to the embodiment of the invention.

FIG. 6 is a table showing Sag values of object-side surfaces and sensor-side surfaces of seventh and eighth lenses according to the embodiment of the invention.

FIG. 7 is a graph of diffraction MTF of an optical system according to the embodiment of the invention.

FIG. 8 is a graph showing aberration characteristics of the optical system according to the embodiment of the invention.

FIG. 9 is a graph showing a curve connecting points passing through the ends of effective regions of lenses according to the embodiment of the invention as a two-dimensional function.

FIG. 10 is a graph showing a straight line connecting points passing through ends of an effective region from the n-4th lens to the nth lens according to the embodiment of the invention as a one-dimensional function.

FIG. 11 is a graph showing Sag values for object-side surfaces and sensor-side surfaces of the nth and n-1th lenses according to the embodiment of the invention.

FIG. 12 is a diagram illustrating that a camera module according to an embodiment is applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to ±0.4 mm depending on the measurement method. The paraxial region refers to a very narrow region near the optical axis, and is a region in which a distance at which a light ray falls from the optical axis OA is almost zero. Hereinafter, the concave or convex shape of the lens surface will be described as an optical axis, and may also include a paraxial region.

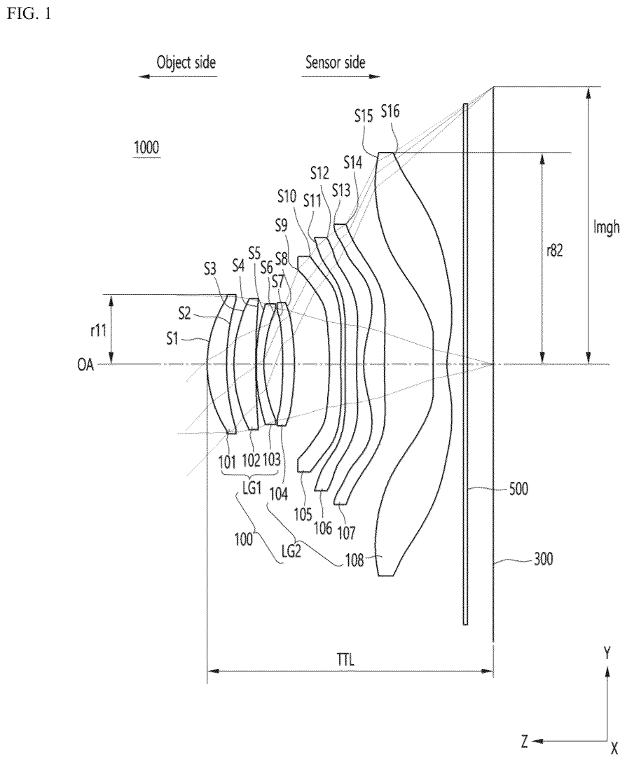

FIG. 1 is a diagram showing an optical system 1000 and a camera module having the same according to an embodiment of the invention.

Referring to FIG. 1, an optical system 1000 or a camera module may include a plurality of lens groups LG1 and LG2, In detail, each of the plurality of lens groups LG1 and LG2 includes at least one lens. For example, the optical system 1000 may include a first lens group LG1 and a second lens group LG2 sequentially disposed along the optical axis OA toward the image sensor 300 from the object side. The number of lenses of the second lens group LG2 may be greater than the number of lenses of the first lens group LG1, for example, 1.5 times or more and 2 times or less of the number of lenses of the first lens group LG1.

The first lens group LG1 may include two or more lenses or four or less lenses. The first lens group LG1 may be, for example, three lenses. The second lens group LG2 may include four or more lenses. The second lens group LG2 may include more lenses than the number of lenses of the first lens group LG1, for example, 6 or less. The number of lenses of the second lens group LG2 may be four or more greater than the number of lenses of the first lens group LG1, and may include, for example, five lenses. The optical system 1000 may include ten or less lenses or nine lenses or less.

In the optical system 1000, a total track length (TTL) may be less than 70% of the diagonal length of the image sensor 300, and may be, for example, in the range of 40% to 69% or 50% to 65%. The TTL is a distance in the optical axis OA from the object-side surface of the lens closest to the object side to the surface of the image sensor 300, the diagonal length of the image sensor 300 is the maximum diagonal length of the image sensor 300, and may be twice the distance Imgh from the optical axis OA to the diagonal end. Accordingly, it is possible to provide a slim optical system and a camera module having the same. The total number of lenses of the first and second lens groups LG1 and LG2 is 7 to 9.

The first lens group LG1 may have positive (+) refractive power. The second lens group LG2 may have a different negative (−) refractive power than the first lens group LG1. The first lens group LG1 and the second lens group LG2 have different focal lengths and different refractive powers, and thus may have good optical performance at the center portion and the periphery portion of the FOV. The refractive power is the reciprocal of the focal length.

The lenses of the first lens group LG1 may be stacked in a meniscus shape convex toward the object side. The second lens group LG2 may have a meniscus shape in which a first lens on the object side is convex toward the sensor side. The first lens group LG1 refracts the light incident through the object side to converge, and the second lens group LG2 converts the light emitted through the first lens group LG1 so as to diffuse to the periphery of the image sensor 300. Accordingly, the two lens surfaces facing each other in the first and second lens groups Lt and LG2, for example, a sensor-side surface of the first lens group LG1 are concave on the optical axis, and an object-side surface of the second lens group LG2 may be concave on the optical axis. In addition, the two lenses facing each other in the first and second lens groups LG1 and LG2 may have refractive powers opposite to each other.

When expressed as an absolute value, the focal length of the second lens group LG2 may be greater than that of the first lens group LG1. For example, the absolute value of the focal length F_LG2 of the second lens group LG2 may be 1.5 times or more, for example, in the range of 1.5 to 3.5 times the absolute value of the focal length F_LG1 of the first lens group LG1. Accordingly, the optical system 1000 according to the embodiment may have improved aberration control characteristics such as chromatic aberration and distortion aberration by controlling the refractive power and focal length of each lens group, and good optical performance in the center and periphery portions of the FOV.

In the optical axis OA, the first lens group LG1 and the second lens group LG2 may have a set distance. The optical axis distance between the first lens group LG1 and the second lens group LG2 on the optical axis OA is a separation distance on the optical axis OA, and may be an optical axis distance between the sensor-side surface of the lens closest to the sensor side among the lenses in the first lens group LG1 and the object-side surface of the lens closest to the object side among the lenses in the second lens group LG2. The optical axis distance between the first lens group LG1 and the second lens group LG2 may be greater than the center thickness of the last lens of the first lens group LG1 and greater than the center thickness of the first lens of the second lens group LG2. The optical axis distance between the first lens group LG1 and the second lens group LG2 may be 26% or more of the optical axis distance of the first lens group LG1, for example, in a range of 26% to 36% of the optical axis distance of the first lens group LG1. Here, the optical axis distance of the first lens group LG1 is a distance in the optical axis between the object-side surface of the lens closest to the object side of the first lens group LG1 and the sensor-side surface of the lens closest to the sensor side.

The optical axis distance between the first lens group LG1 and the second lens group LG2 may be 15% or less of the optical axis distance of the second lens group LG2, for example, in a range of 5% to 15% or 6% to 13%. The optical axis distance of the second lens group LG2 is a distance in the optical axis between the object-side surface of the lens closest to the object side of the second lens group LG2 and the sensor-side surface of the lens closest to the sensor side.

A lens having the smallest effective diameter in the first lens group LG1 may be a lens closest to the second lens group LG2. A lens having the smallest effective diameter in the second lens group LG2 may be a lens closest to the first lens group LG1 Here, the size of the effective diameter is an average value of the effective diameter of the object-side surface and the effective diameter of the sensor-side surface of each lens. Accordingly, the optical system 1000 may have good optical performance not only at the center portion of the FOV but also at the periphery portion, and chromatic aberration and distortion aberration may be improved. A size of a lens having a minimum effective diameter in the first lens group LG1 may be smaller than a size of a lens having a minimum effective diameter in the second lens group LG2.

A difference between the effective diameters of the lenses having the smallest effective diameters in the first lens group LG1 and the second lens group LG2 may be 0.2 mm or less. Accordingly, the incident light may be refracted to an effective region between the first and second lens groups LG1 and LG2 and then refracted to the periphery portion of the image sensor 300.

Among the lenses of the first lens group LG1, the lens closest to the object side has positive (+) refractive power, and among the lenses of the second lens group LG2, the lens closest to the sensor side may have negative (−) refractive power. In the optical system 1000, the number of lenses having positive (+) refractive power may be equal to the number of lenses having negative (−) refractive power. In the second lens group LG2, the number of lenses having positive (±) refractive power may be smaller than the number of lenses having negative (−) refractive power. Two lenses facing each other in a region between the first and second lens groups LG1 and LG2 may have different refractive powers.

Each of the plurality of lenses may include an effective region and a non-effective region. The effective region may be a region through which light incident on each of the lenses passes. That is, the effective region may be an effective region or an effective diameter region in which optical properties are implemented by refracting incident light. The non-effective region may be arranged around the effective region. The non-effective region may be a region in which effective light from the plurality of lenses is not incident. That is, the non-effective region may be a region unrelated to the optical characteristics. Also, an end of the non-effective region may be a region fixed to a barrel (not shown) accommodating the lens.

The optical system 1000 may include an image sensor 300. The image sensor 300 may detect light and convert it into an electrical signal. The image sensor 300 may detect light sequentially passing through the plurality of lenses 100. The image sensor 300 may include a device capable of sensing incident light, such as a charge coupled device (CCD) or a complementary metal oxide semiconductor (CMOS). The diagonal length of the image sensor 300 may be greater than 8 mm, for example greater than 8 mm and less than 30 mm. Preferably, Imgh of the image sensor 300 may be smaller than TTL.

The optical system 1000 may include an optical filter 500. The optical filter 500 may be disposed between the second lens group LG2 and the image sensor 300. The optical filter 500 may be disposed between a lens closest to a sensor side among the plurality of lenses 100 and the image sensor 300. For example, when the optical system 100 has 8 lenses, the optical filter 500 may be disposed between the eighth lens 108 and the image sensor 300.

The optical filter 500 may include an infrared filter. The optical filter 500 may pass light of a set wavelength band and filter light of a different wavelength band. When the optical filter 500 includes an infrared filter, radiant heat emitted from external light may be blocked from being transferred to the image sensor 300. In addition, the optical filter 500 may transmit visible light and reflect infrared light. As another example, a cover glass may be further disposed between the optical filter 500 and the image sensor 300.

The optical system 1000 according to the embodiment may include an aperture stop ST. The aperture stop ST may be a stopper for adjusting the amount of light incident on the optical system 1000. The aperture stop ST may be disposed around at least one lens of the first lens group LG1. For example, the aperture stop ST may be disposed around an object-side surface or a sensor-side surface of the second lens 102. The aperture stop ST may be disposed between two adjacent lenses 101 and 102 among the lenses in the first lens group LG1, Alternatively, at least one lens selected from among the plurality of lenses 100 may serve as an aperture stop. In detail, an object-side surface or a sensor-side surface of one lens selected from among the lenses of the first lens group LG11 may serve as an aperture stop for adjusting the amount of light.

A straight distance from the aperture stop ST to the sensor-side surface of the n-th lens may be smaller than an optical axis distance from the object-side surface of the first lens 101 to the sensor-side surface of the n-th lens. When SD is a distance in the optical axis from the aperture stop ST to the sensor-side surface of the n-th lens, it may satisfy: SD<EFL or/and SD<Ingh. In addition, the following condition may satisfy: SD<TTL. EFL is the effective focal length of the entire optical system and may be defined as F. The following condition may satisfy: F S Imgh, and a difference between F and Imgh may be 0.5 mm or less. The FOV of the optical system 1000 may be less than 120 degrees, for example, more than 70 degrees and less than 100 degrees. The F number (F#) of the optical system 1000 may be greater than 1 and less than 10, for example, 1.1≤F#≤5. Also, the F# may be smaller than the entrance pupil diameter (EPD). Accordingly, the optical system 1000 has a slim size, may control incident light, and may have improved optical characteristics within the FOX.

The effective diameter of the lenses may gradually decrease from the object side lens to the lens surface between the first and second lens groups LG1 and LG2, and may gradually increase from the lens surface between the first and second lens groups LG1 and LG2 to the lens surface of the last lens.

The optical system 1000 according to the embodiment may further include a reflective member (not shown) for changing a path of light. The reflective member may be implemented as a prism that reflects incident light of the first lens group LG1 toward the lenses. Hereinafter, an optical system according to an embodiment will be described in detail.

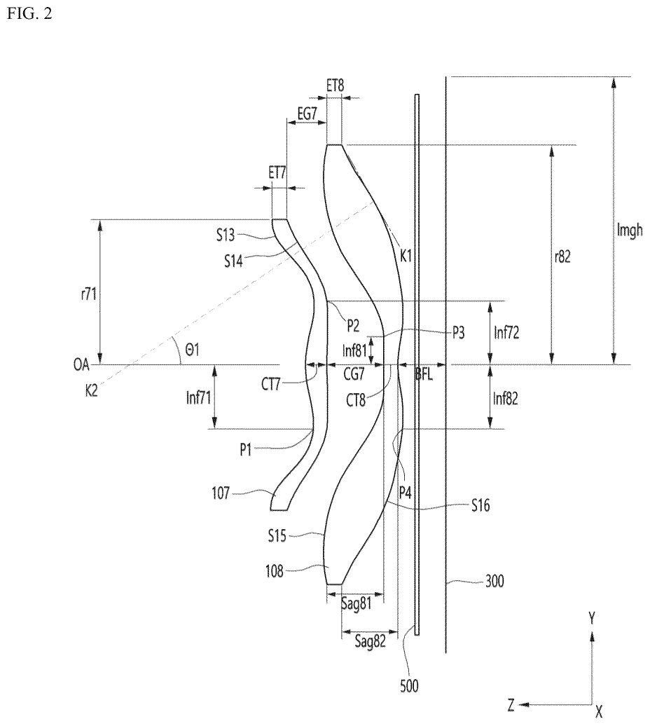

FIG. 1 is a configuration diagram of an optical system and a camera module according to an embodiment of the invention, and FIG. 2 is an explanatory diagram showing the relationship between an image sensor, an n-th lens, and an n-1th lens of the optical system of FIG. 1.

Referring to FIGS. 1 and 2, an optical system 1000 according to an embodiment includes a lens portion 100 having a plurality of lenses, and the lens portion 100 includes first lenses 101 to eighth lenses 108 may be included. The first to eighth lenses 101 to 108 may be sequentially aligned along the optical axis OA of the optical system 1000. Light corresponding to object information may pass through the first lens 101 to the eighth lens 108 and the optical filter 500 and be incident to the image sensor 300.

The first lens group LG1 may include the first to third lenses 101, 102, and 103, and the second lens group LG2 may include the fourth to eighth lenses 104 to 108. The optical axis distance between the third lens 103 and the fourth lens 104 may be a distance in the optical axis between the first and second lens groups LG1 and LG2.

Among the first to eighth lenses 101 to 108, the number of lenses having a meniscus shape convex toward the object side on the optical axis may be 5 or more, and for example, n-2 of the total number of lenses. The n is the total number of lenses, and may be, for example, 8.

The first lens 101 may have negative (−) or positive (+) refractive power on the optical axis OA and may preferably have positive (+) refractive power. The first lens 101 may include a plastic or glass material. For example, the first lens 101 may be made of a plastic material.

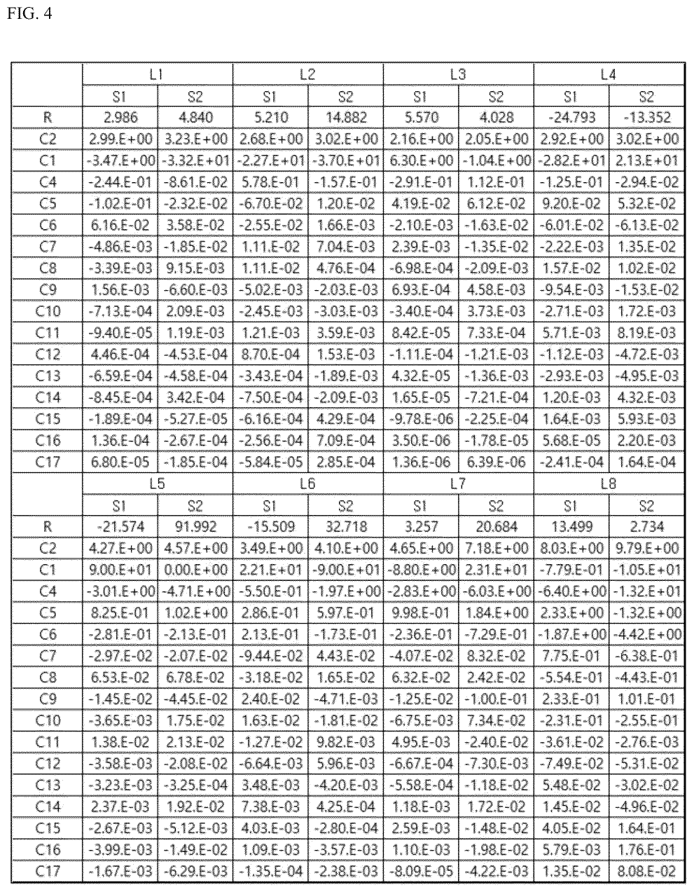

The first lens 101 may include a first surface S1 defined as an object-side surface and a second surface S2 defined as a sensor-side surface. On the optical axis OA, the first surface S1 may have a convex shape, and the second surface S2 may have a concave shape. That is, the first lens 101 may have a meniscus shape convex toward the object side on the optical axis OA At least one of the first surface S1 and the second surface S2 may be an aspherical surface. For example, both the first surface S1 and the second surface S2 may be aspherical. Aspherical coefficients of the first and second surfaces S1 and S2 are provided as shown in FIG. 4, LA is the first lens 101, L1S1 is the first surface, and L1 S2 is the second surface.

The second lens 102 may have positive (+) or negative (−) refractive power on the optical axis OA. The second lens 102 may have negative (−) refractive power. The second lens 102 may include a plastic or glass material. For example, the second lens 102 may be made of a plastic material.

The second lens 102 may include a third surface S3 defined as an object-side surface and a fourth surface S4 defined as a sensor-side surface. On the optical axis OA, the third surface S3 may have a convex shape, and the fourth surface S4 may have a concave shape. That is, the second lens 102 may have a meniscus shape convex toward the object side on the optical axis OA. Alternatively, on the optical axis OA, the third surface S3 may have a convex shape, and the fourth surface S4 may have a convex shape. At least one of the third and fourth surfaces S3 and S4 may be an aspherical surface. For example, both the third surface S3 and the fourth surface S4 may be aspheric surfaces. Aspheric coefficients of the third and fourth surfaces S3 and S4 are provided as shown in FIG. 4, L2 is the second lens 102, L2S1 is the third surface, and L2S2 is the fourth surface.

The third lens 103 may have positive (+) or negative (−) refractive power on the optical axis OA, and may preferably have positive (+) refractive power. The third lens 103 may include a plastic or glass material. For example, the third lens 103 may be made of a plastic material.

The third lens 103 may include a fifth surface S5 defined as an object-side surface and a sixth surface S6 defined as a sensor-side surface. On the optical axis OA, the fifth surface S5 may have a convex shape, and the sixth surface S6 may have a concave shape. That is, the third lens 103 may have a meniscus shape convex toward the object side on the optical axis OA. Alternatively, on the optical axis OA, the fifth surface S5 may have a concave shape, and the sixth surface S6 may have a concave shape. Alternatively, the third lens 103 may have a meniscus shape convex toward the sensor side. At least one of the fifth surface S5 and the sixth surface S6 may be an aspheric surface. For example, both the fifth surface S5 and the sixth surface S6 may be aspheric surfaces. Aspheric coefficients of the fifth and sixth surfaces S5 and S6 are provided as shown in FIG. 4, L3 is the third lens 103, L3S1 is the fifth surface, and L3S2 is the sixth surface.

In the third lens 103, the effective radius of the fifth surface S5 may be greater than the effective radius of the sixth surface S6. The refractive index of the third lens 103 is greater than 1.6 and may be greater than the refractive index of the first and second lenses 101 and 102. The Abbe number of the third lens 103 is less than 50 and may be smaller than the Abbe numbers of the first and second lenses 101 and 102.

The fourth lens 104 may have positive (+) or negative (−) refractive power on the optical axis OA. The fourth lens 104 may have positive (+) refractive power. The fourth lens 104 may include a plastic or glass material. For example, the fourth lens 104 may be made of a plastic material. When an absolute value is expressed, the focal length of the fourth lens 104 may be greater than the focal length of the seventh lens 107, and for example, the following condition may satisfy: 5<|F4|−|F7|<30. Here, the following condition may satisfy: 10<|F4|<25. The fourth lens 104 may have the largest focal length among lenses.

The fourth lens 104 may include a seventh surface S7 defined as an object-side surface and an eighth surface S8 defined as a sensor-side surface. On the optical axis OA, the seventh surface S7 may have a concave shape, and the eighth surface S8 may have a convex shape. That is, the fourth lens 104 may have a meniscus shape convex toward the sensor side on the optical axis OA. Alternatively, the fourth lens 104 may have a concave shape on both sides of the optical axis. Alternatively, the fourth lens 104 may have a convex shape on both sides of the optical axis OA. At least one or all of the seventh and eighth surfaces S7 and S8 of the fourth lens 104 may be provided without a critical point. At least one of the seventh surface S7 and the eighth surface S8 may be an aspherical surface. For example, both the seventh surface S7 and the eighth surface S8 may be aspheric surfaces, and the aspherical surface coefficient is provided as shown in FIG. 4, L4 is the fourth lens 104, and L4S1 is the seventh surface, and L4S2 is the eighth surface.

The effective radius of the sixth surface S6 of the third lens 103 and/or the seventh surface S7 of the fourth lens 104 may be the smallest among the effective diameters of the object-side surface and the sensor-side surface of the lenses. A difference in effective radius between the sixth surface S6 of the third lens 103 and the seventh surface S7 of the fourth lens 104 may be 0.15 mm or less. Accordingly, light loss due to the two lens surfaces facing each other in the region between the first and second lens groups LG1 and LG2 may be reduced.

The fifth lens 105 may have positive (+) or negative (−) refractive power on the optical axis OA The fifth lens 105 may have negative (−) refractive power. The fifth lens 105 may include a plastic or glass material. For example, the fifth lens 105 may be made of a plastic material.

The fifth lens 105 may include a ninth surface S9 defined as an object-side surface and a tenth surface S10 defined as a sensor-side surface. On the optical axis OA, the ninth surface S9 may have a concave shape, and the tenth surface S10 may have a concave shape, That is, the both sides of the fifth lens 105 may have a concave shape on the optical axis OA. Alternatively, the fifth lens 105 may have a meniscus shape convex toward the object side. Alternatively, the both sides of the fifth lens 105 may have a convex shape on the optical axis. Alternatively, the fifth lens 105 may have a meniscus shape convex toward the sensor side on the optical axis OA. At least one or all of the ninth and tenth surfaces S9 and S10 of the fifth lens 105 may be provided without a critical point. At least one of the ninth surface S9 and the tenth surface S10 may be an aspherical surface. For example, both the ninth surface S9 and the tenth surface S10 may be aspheric surfaces, the aspherical surface coefficients are provided as shown in FIG. 4, L5 is the fifth lens 105, and L5S1 is the ninth surface, and L5S2 is the tenth surface.

The sixth lens 106 may have positive (+) or negative (−) refractive power on the optical axis OA The sixth lens 106 may have negative (−) refractive power. The sixth lens 106 may include a plastic or glass material. For example, the sixth lens 106 may be made of a plastic material.

The sixth lens 106 may include an eleventh surface S11 defined as an object-side surface and a twelfth surface S12 defined as a sensor-side surface. The eleventh surface S11 may have a concave shape on the optical axis OA, and the twelfth surface S12 may have a concave shape. That is, the both sides of the sixth lens 106 may have a concave shape on the optical axis OA. Alternatively, the sixth lens 1060 may have a meniscus shape convex toward the sensor side. Alternatively, the sixth lens 106 may have a meniscus shape convex toward the object side. Alternatively, the sixth lens 106 may have a meniscus shape convex toward the object side. The sixth lens 106 may have a convex shape on both sides. At least one or all of the eleventh and twelfth surfaces S11 and S12 of the sixth lens 106 may be provided without a critical point. At least one of eleventh S11 and the twelfth surface S12 may be an aspherical surface. is provided as shown in FIG. 4, L6 is the sixth lens 106, L6S1 is the eleventh surface, and L6S2 is the twelfth surface.

The seventh lens 107 may have positive (−) or negative (−) refractive power on the optical axis OA. The seventh lens 107 is an n-1th lens and may have positive (+) refractive power. The seventh lens 107 may include a plastic or glass material. For example, the seventh lens 107 may be made of a plastic material.

The seventh lens 107 may include a thirteenth surface S13 defined as an object-side surface and a fourteenth surface S14 defined as a sensor-side surface. The thirteenth surface S13 may have a convex shape on the optical axis OA, and the fourteenth surface S14 may have a concave shape on the optical axis OA. That is, the seventh lens 107 may have a meniscus shape convex toward the object side on the optical axis OA. Alternatively, the seventh lens 107 may have a meniscus shape convex toward the sensor side. Alternatively, the seventh lens 107 may have a shape in which both sides are concave or both sides are convex on the optical axis OA. At least one or both of the thirteenth and fourteenth surfaces S13 and S14 of the seventh lens 107 may have a critical point. At least one of the thirteenth surface S13 and the fourteenth surface S14 may be an aspheric surface. For example, both the thirteenth surface S13 and the fourteenth surface S14 may be aspheric surfaces, and the aspherical surface coefficient is provided as shown in FIG. 4, L7 is the seventh lens 107, and L7S1 is the thirteenth surface, and L7S2 is the fourteenth surface.

The eighth lens 108 is an n-th lens and may have negative (−) refractive power on the optical axis OA. The eighth lens 108 may include a plastic or glass material. For example, the eighth lens 108 may be made of a plastic material. The eighth lens 108 may be a lens closest to the sensor side of the optical system 1000 or a last n-th lens.

The eighth lens 108 may include a fifteenth surface S15 defined as an object-side surface and a sixteenth surface S16 defined as a sensor-side surface. On the optical axis OA, the fifteenth surface S15 may have a convex shape, and the sixteenth surface S16 may have a concave shape. That is, the eighth lens 108 may have a meniscus shape convex toward the object side on the optical axis OA Alternatively, the eighth lens 108 may have a convex meniscus shape toward the sensor side on the optical axis or a concave shape on both sides. At least one or all of the fifteenth and sixteenth surfaces S15 and S16 of the eighth lens 108 may have a critical point. The fifteenth and sixteenth surfaces S15 and S16 may be aspheric surfaces, and the aspherical surface coefficient is provided as shown in FIG. 4, L8 is the eighth lens 108, L8S1 is the fifteenth surface, and L8S2 is the sixteenth surface.

As shown in FIG. 2, each of the thirteenth surface S13 and the fourteenth surface S14 of the seventh lens 107 may have at least one critical point P1 or P2 from the optical axis OA to the end of the effective region. Each of the fifteenth surface S15 and the sixteenth surface S16 of the eighth lens 108 may have at least one critical point P3 or P4 from the optical axis OA to the end of the effective region. The critical point is a point at which the sign of the slope value with respect to the optical axis OA and the direction perpendicular to the optical axis OA changes from positive (+) to negative (−) or from negative (−) to positive (+), and may mean a point at which the slope value is zero. Also, the critical point may be a point at which the slope value of a tangent passing through the lens surface decreases as it increases, or a point where the slope value increases as it decreases.

A distance from the optical axis OA to the ends of the effective regions of the thirteenth and fourteenth surfaces S13 and S14 of the seventh lens 107 is an effective radius, and may be defined as r71 and r72. A distance from the optical axis OA to the end of the effective region of each of the fifteenth surface S15 and sixteenth surface S16 of the eighth lens 108 is an effective radius, and may be defined as r81 and r82.

The distances to the critical points of the thirteenth, fourteenth, fifteenth, and sixteenth S13, S14, S15, and S16 may be defined as follows.

Inf71: straight distance from the center of the thirteenth surface S13 to the first critical point P1

Inf72: straight distance from the center of the fourteenth surface 514 to the second critical point P2

Inf81: straight distance from the center of the fifteenth surface S15 to the third critical point P3

Inf82: straight distance from the center of the sixteenth surface S16 to the fourth critical point P4

The distances to the critical points may have the following relationship.

Inf72≤Inf71

Inf81<Inf71<Inf82

The effective radii r71, r72, r81, and r82 and the distances Inf71, Inf72, Inf81, and Inf82 to the critical points P1, P2, P3, and P4 may satisfy the following relational expression from the optical axis.

0.35<Inf71/r71<0.50

0.32<Inf72/r72<0.46

0.01<Inf1/r81<0.15

0.21<Inf82/r82<0.35

The locations of the first, second, and fourth critical points P1, P2, and P4 may be located within a range of 2.5 mm or less from the optical axis OA, for example, within a range of 1.1 mm to 2.5 mm, and the third critical point P3 may be located within a range of 1 mm or less, for example, 0.1 mm to 1.0 mm based on the optical axis.

The third critical point P3 may be located closer to the optical axis OA than the first and second critical points P1 and P2, and the fourth critical point P4 may be located closer to the edge than the second and third critical points P2 and P3. Accordingly, the seventh lens 107 may refract the incident light to the periphery, and the eighth lens 108 may refract the incident light to the periphery portion of the image sensor 300.

It is preferable that the positions of the critical points of the seventh and eighth lenses 107 and 108 is disposed at a position that satisfies the above range in consideration of the optical characteristics of the optical system 1000. In detail, the locations of the critical points preferably satisfy the range described above for controlling optical characteristics such as chromatic aberration, distortion characteristics, aberration characteristics, and resolving power of the optical system 1000. Accordingly, the path of light emitted to the image sensor 300 through the lens may be effectively controlled. Therefore, the optical system 1000 according to the embodiment may have improved optical characteristics even in the center and periphery portions of the FOV.

In addition, the normal line K2, which is a straight-line perpendicular to the tangent line K1 passing through an arbitrary point of the sixteenth surface S16 on the sensor-side surface of the eighth lens 108, which is the last lens, may have a predetermined angle θ1 from the optical axis OA, and the maximum angle of the angle θ1 may be greater than 5 degrees and less than 65 degrees, for example, in the range of 20 degrees to 50 degrees or in the range of 20 degrees to 40 degrees. Accordingly, since the Sag value in the sensor-side direction is not large based on a straight-line orthogonal to the optical axis of the sixteenth surface S16, a slim optical system may be provided.

Here, a normal line perpendicular to the tangent passing through the fifteenth surface S15 of the eighth lens 108 has a second angle θ2 with respect to the optical axis, a normal line perpendicular to the tangent passing through the fourteenth surface S14 of the seventh lens 107 has a third angle θ3 with respect to the optical axis, and a normal line perpendicular to the tangent passing through the thirteenth surface S13 of the seventh lens 107 has a fourth angle θ2 with respect to the optical axis. When the first to fourth angles θ1, θ2, θ3, and θ4 are maximum, the following relationship may be satisfied.

The condition satisfies: θ1>θ2, and θ1 and θ2 may range from 50 degrees or less, for example, from 20 degrees to 50 degrees.

The condition satisfies: θ4≤θ2≤θ3<θ1, and θ3 and θ4 may range from 50 degrees or less, for example, from 20 degrees to 50 degrees. A difference between the maximum first to fourth angles θ1, θ2, θ3, and θ4 may be 10 degrees or less.

A section in which each of the first to fourth angles θ1, θ2, θ3, and θ4 is 30 degrees or more on the thirteenth surface S13 to the sixteenth surface S16 may have the following relationship from the optical axis.

5≤θ1≤6.4

2.5≤θ2≤3.0

3.2≤θ3≤3.9

2.8≤θ4≤3.1

Also, positions starting at 30 degrees or more from the relationships may be in the order of the fifteenth surface S15, the thirteenth surface S13, the fourteenth surface S14, and the sixteenth surface S16 from the optical axis.

On the optical axis,

The curvature radii of the first and second surfaces St and S2 of the first lens 101 are L1R1 and L1R2,

The curvature radii of the third and fourth surfaces S3 and S4 of the second lens 102 are L2R1 and L2R2,

The curvature radii of the fifth and sixth surfaces S5 and S6 of the third lens 103 are L3R and L3R2,

The curvature radii of the seventh and eighth surfaces S7 and S8 of the fourth lens 104 are L4R1 and L4R2.

The curvature radii of the ninth and tenth surfaces S9 and S10 of the fifth lens 105 are L5R1 and L5R2,

The curvature radii of the eleventh and twelfth surfaces S11 and S12 of the sixth lens 106 are L6R1 and L6R2,

The curvature radii of the thirteenth and fourteenth surfaces S13 and S14 of the seventh lens 107 are L7R1 and L7R2, and

The curvature radii of the fifteenth and sixteenth surfaces S15 and S16 of the eighth lens 108 may be defined as L8R1 and L8R2. The curvature radii may satisfy at least one of the following conditions 1 to 9 in order to improve the aberration characteristics of the optical system.

L1R1+L1R2<L2R2 Condition 1:

L2R1<L2R2 Condition 2:

L3R1+L3R2<L2R2 Condition 3:

L8R1*L8R2<|L5R2| Condition 4:

L7R1+L7R2<L6R2 Condition 5:

L7R1*L7R2<|L5R2|(However, the relationship satisfies:L7R1<L7R2) Condition 6:

L8R1+L8R2<L7R1+L7R2 Condition 7:

|L6R1*L6R2|<L3R1*L3R2 Condition 8:

L4R1+L4R2<L5R1+L5R2(However, the relationship satisfies:L5R1<L5R2) Condition 9:

In the optical system, the curvature radius of the eighteenth surface S18 of the eighth lens 108 may be minimum, and the difference from the curvature radius of the first surface S1 of the first lens 101 may be 1 mm or less. The curvature radius (absolute value) of the tenth surface S10 of the fifth lens 105 may be the maximum or greater than 50 mm. By setting such a curvature radius, good optical performance may be provided at the focal length of each lens.

The effective diameter of the eighth lens 108 may have a maximum effective diameter and may be 12 mm or more. The effective diameter of the eighth lens 108 is the average of the effective diameters of the object-side surface and the sensor-side surface. The effective diameter of the eighth lens 106 may be twice or more than the curvature radius (absolute value) of the fifth lens 105.

On the optical axis,
The effective diameters of the first and second surfaces S1 and S2 of the first lens 101 are CA_L1S1 and CA_L1S2,
The effective diameters of the third and fourth surfaces S3 and S4 of the second lens 102 are CA_L2S1 and CA_L2S2,
The effective diameters of the fifth and sixth surfaces S5 and S6 of the third lens 103 are CA_L3S1 and CA_L3S2,
The effective diameters of the seventh and eighth surfaces S7 and S8 of the fourth lens 104 are CA_L4S1 and CA_L4S2,
The effective diameters of the 9th and 10th surfaces S9 and S10 of the fifth lens 105 are CA_L5S1 and CA_L5S2,
The effective diameters of the eleventh and twelfth surfaces S11 and S12 of the sixth lens 106 are CA_L6S1 and CA_L6S2,
The effective diameters of the thirteenth and fourteenth surfaces S13 and S14 of the seventh lens 107 are CA_L7S1 and CA_L7S2, and
The effective diameters of the fifteenth and sixteenth surfaces S16 and S16 of the eighth lens 108 may be defined as CA_L8S1 and CA_L8S2. These effective diameters are factors that affect the aberration characteristics of the optical system, and may satisfy at least one of the following conditions.

$$CA\_L3S2 < CA\_L3S1 < CA\_L2S1 < CA\_L1S1$$

$$CA\_L5S1 < CA\_L5S2 < CA\_L6S1 < CA\_L6S2$$

$$CA\_L6S2 < CA\_L7S1 < CA\_L7S2 < CA\_L8S1 < CA\_L8S2$$

$$CA\_L4S1 - CA\_L3S2 < CA\_L3S1 - CA\_L3S2$$

$$CA\_L5S1 + CA\_L5S2 < CA\_L8S2$$

$$L 1 R 1 + L 1 R 2 < CA\_L8S2$$

Among the first to eighth lenses 101 to 108, the third lens 103 may have the smallest average size of the effective diameter of the lenses, and the eighth lens 108 may have the largest average size. The size of the effective diameter of the sixth surface S6 or the seventh surface S7 may be the smallest, and the size of the effective diameter of the sixteenth surface S16 may be the largest. The size of the effective diameter of the eighth lens 108 is the largest, so that incident light may be effectively refracted toward the image sensor 300. Accordingly, the optical system 1000 may have improved chromatic aberration control characteristics, and may improve vignetting characteristics of the optical system 1000 by controlling incident light.

In the optical system, the number of lenses having a refractive index exceeding 1.6 may be 3 or less, and the number of lenses having a refractive index of less than 1.6 may be 4 or more. The average refractive index of the first to eighth lenses 101 to 108 may be 1.55 or more. In the optical system, the number of lenses having an Abbe number greater than 45 may be equal to the number of lenses having an Abbe number less than 45. An average Abbe number of the first to eighth lenses 101 to 108 may be 45 or less. By setting the refractive index and Abbe number of each lens, the effect of chromatic aberration may be controlled.

Referring to FIG. 2, a back focal length (BFL) is an optical axis distance from the image sensor 300 to the last lens. That is, the BFL is a distance in the optical axis between the image sensor 300 and the sensor-side sixteenth surface S16 of the eighth lens 108. CT7 is a center thickness or optical axis thickness of the seventh lens 107, and L7_ET is the end or edge thickness of the effective region of the seventh lens 107. CT8 is a center thickness or optical axis thickness of the eighth lens 108. CG7 is an optical axis distance between the seventh lens 107 and the eighth lens 108 (i.e., center distance). That is, the optical axis distance CG7 between the seventh lens 107 and the eighth lens 108 is the distance between the fourteenth surface S14 and the fifteenth surface S15 in the optical axis ON The CG7 may be greater than the optical axis distance between the third and fourth lenses 103 and 104. The CG7 may be greater than the sum of center thicknesses of the seventh and eighth lenses 107 and 108. The CG7 may be the largest among optical axis distances between two adjacent lenses. The CG7 may be 40% or more of the optical axis distance from the first surface S1 of the first lens 101 to the fourteenth surface S14 of the seventh lens 107, for example, in a range of 40% to 48%. By increasing the optical axis distance CG7 between the seventh and eighth lenses 107 and 108, a difference of the effective diameters between the seventh and eighth lenses 107 and 108 may be increased, and a slim optical system with improved optical performance may be provided.

The center distance CG7 between the seventh lens 107 and the eighth lens 108 is the maximum among the distances between the lenses, and the optical axis distance between the second and third lenses 102 and 103 is the smallest of the distances between the lenses. Among the first to eighth lenses 101 to 108, the second lens 102 has the largest center thickness. The center thickness CT2 of the second lens 102 may be smaller than the optical axis distance between the fourth and fifth lenses 104 and 105 and smaller than the optical axis distance CG7 between the seventh and eighth lenses 107 and 108. A lens having a minimum center thickness may be the third lens 103.

Among the lenses 101 to 108, the maximum center thickness may be twice or more, for example, 2 to 5 times the minimum center thickness. Among the lenses, the number of lenses having a center thickness of less than 0.5 mm may be greater than the number of lenses having a center thickness of 0.5 mm or more, and is four or more. The average of the center thickness of the lenses may be less than 0.5 mm. The optical system 1000 having the image sensor 300 with a size of around 1 inch may be provided in a structure having a slim thickness.

Also, the sum of center thicknesses of the first to eighth lenses 101 to 108 may be smaller than the sum of center distances between the first to eighth lenses 101 to 108. Accordingly, the optical system 1000 may control incident light and may have improved aberration characteristics and resolution.

When the focal length of each lens 101 to 108 is defined as F1, F2, F3, F4, F5, F6, F7, and F8, the following conditions may satisfy: F2<F4 and F1<F3, in absolute values, and the following condition may satisfy: F8<F5<F4. The resolution may be affected by adjusting the focal length. When the focal length is described as an absolute value, the focal length of the fourth lens 104 may be the largest among the lenses, the focal length of the eighth lens 108 is the minimum, and a difference between the focal lengths of the seventh and eighth lenses 107 and 108 may be 3 or less. The maximum focal distance may be six times or more than the minimum focal distance.

When the refractive index of each lens 101 to 108 is n1, n2, n3, n4, n5, n6, n7, and n8, the Abbe number of each lens 101 to 108 is v1, v2, v, v4, v5, v6, v7, and v8, the refractive index may satisfy the condition: n1<n3, the n1, n2, n4, n7, and n8 are less than 1.6 and may have a difference of 0.2 or less from each other, and the n3, n5, and n6 are greater than 1.60. The Abbe number may satisfy the condition: v3<v2, the v1, v2, v4, and v8 may be 45 or more and may have a difference of 10 or less from each other, and the v3 may be less than 45, for example, 30 or less. Accordingly, the optical system 1000 may have improved chromatic aberration control characteristics.

The optical system 1000 according to the embodiment disclosed above may satisfy at least one or two or more of equations described below. Accordingly, the optical system 1000 according to the embodiment may have improved optical characteristics. For example, when the optical system 1000 satisfies at least one equation, the optical system 1000 may effectively control aberration characteristics such as chromatic aberration and distortion aberration, and may have good optical performance not only in the center portion of the FOV but also in the periphery portion. The optical system 1000 may have improved resolving power and may have a slimmer and more compact structure.

Hereinafter, the center thickness of the first to eighth lenses 101 to 108 may be defined as CT1-CT8, the edge thickness may be defined as ET1-ET8, the optical axis distance between the two adjacent lenses may be defined as CG1 to CG7 from the distance between the first and second lenses to the distance between the seventh and eighth lenses, and the distance between the edges of the adjacent two lenses may be defined as EG1 to EG8 from the distance between the first and second lenses to the distance between the seventh and eighth lenses. The unit of the thickness and distance is mm.

$$0 < CT 1 / CT 2 < 1.5 \qquad [ Equation 1 ]$$

In Equation 1, when the thickness CT1 of the first lens 101 in the optical axis OA and the thickness CT2 of the second lens 102 in the optical axis OA are satisfied, the optical system 1000 may improve aberration characteristics. Preferably, Equation 1 above may satisfy: 0.5≤CT1/CT2

$$0 < CT 3 / ET 3 < 1.5 \qquad [ Equation 2 ]$$

In Equation 2, when the thickness CT3 of the third lens 103 in the optical axis and the thickness ET3 at the edge of the effective region of the third lens 103 are satisfied, the optical system 1000 may have chromatic aberration control characteristics. Preferably, Equation 2 above may satisfy: 0<CT3/ET3≤1.

$$2 < CT 1 / ET 1 < 3 \qquad [ Equation 2 - 1 ]$$

$$1 < CT 2 / ET 2 < 3 \qquad [ Equation 2 - 2 ]$$

$$( CT 2 - CT 1 ) < CT 3 \qquad [ Equation 2 - 3 ]$$

$$1 < CT 4 / ET 4 < 2 \qquad [ Equation 2 - 4 ]$$

$$1 < CT 5 / ET 5 < 2 \qquad [ Equation 2 - 5 ]$$

$$0.8 < CT 6 / ET 6 < 1.2 \qquad [ Equation 2 - 6 ]$$

$$2 < CT 7 / ET 7 < 3 \qquad [ Equation 2 - 7 ]$$

$$0 < CT 8 / ET 8 < 1.2 \qquad [ Equation 2 - 8 ]$$

$$0.5 < SD / TD < 1 \qquad [ Equation 2 - 9 ]$$

When the ratios of the center thickness to the edge thickness of the second to eighth lenses 102 to 108 in Equations 2-1 to 2-8 are satisfied, the optical system 1000 may have improved chromatic aberration control characteristics. The SD is the optical axis distance from the aperture stop to the sensor-side sixteenth surface S16 of the eighth lens 108, and the TD is the optical axis distance from the object-side first surface S1 of the first lens 101 to the sensor-side sixteenth surface S16 of the eighth lens 108. The aperture stop may be disposed around the object-side surface of the second lens 102. When the optical system 1000 according to the embodiment satisfies Equation 2-9, chromatic aberration of the optical system 1000 may be improved.

$$3 < F\_LG2 / F\_LG1 < 5 \qquad [ Equation 2 - 10 ]$$

The F_LG1 is the focal length of the first lens group LG1, and the F_LG2 is the focal length of the second lens group LG2. When the optical system 1000 according to the embodiment satisfies Equation 2-10, chromatic aberration of the optical system 1000 may be improved That is, as the value of Equation 2-10 approaches 1, the distortion aberration may be reduced. The value of Equation 2-10 may satisfy: 3<F_LG2/F_LG<4.

$$0 < ET 8 / CT 8 < 3 \qquad [ Equation 3 ]$$

In Equation 3, when the thickness CT8 at the optical axis and the thickness ET8 of the edge of the eighth lens 108 are satisfied, the optical system 1000 may have improved chromatic aberration control characteristics, Equation 3 may satisfy 1≤ET8/CT8<2. In addition, the condition may satisfy: CT6+CT7+CT8<CG7.

$$1.6 < n 3 \qquad [ Equation 4 ]$$

In Equation 4, n3 means the refractive index of the third lens 103 at the d-line. When the optical system 1000 according to the embodiment satisfies Equation 4, the optical system 1000 may improve chromatic aberration characteristics.

$$1.5 < n 1 < 1.6 \qquad [ Equation 4 - 1 ]$$

$$1.5 < n 8 < 1.6$$

In Equation 4-1, n1 is the refractive index of the first lens 101 at the d-line, and n8 is the refractive index of the eighth lens 108 at the d-line. When the optical system 1000 according to the embodiment satisfies Equation 4-1, the effect on the TTL of the optical system 1000 may be suppressed.

$$1.5 < n 2 < 1.6 \qquad [ Equation 4 - 2 ]$$

$$1.5 < n 4 < 1.6$$

In Equation 4-2, n2 and n4 are the refractive indices of the second and fourth lenses 102 and 104 at the d-line. When the optical system 1000 according to the embodiment satisfies Equation 4-2, the optical system 1000 may improve chromatic aberration characteristics.

$$0.5 < L8S2\_max \_Sag to Sensor < 1.5 \qquad [ Equation 5 ]$$

In Equation 5, L8S2_max_Sag to Sensor means the distance from the maximum Sag value of the sensor-side sixteenth surface S16 of the eighth lens 108 to the image sensor 300 in a direction of the optical axis. For example, L8S2_max_Sag to Sensor means the distance from the critical point P4 of the sensor-side surface of the eighth lens 108 to the image sensor 300 in a direction of the optical axis. When the optical system 1000 according to the embodiment satisfies Equation 5, the optical system 1000 may secure a space in which the optical filter 500 may be disposed between the lens portion 100 and the image sensor 300, thereby having improved assemblability. In addition, when the optical system 1000 satisfies Equation 5, the optical system 1000 may secure a distance for module manufacturing. Preferably, the value of Equation 5 may satisfy: 0.8<18S2_max_sag to Sensor<1.2.

In the lens data for the embodiment, the position of the filter 500, in detail, the distance between the last lens and the filter 500, and the distance between the image sensor 300 and the filter 500 are set for convenience in the design of the optical system 1000, and the filter 500 may be freely disposed within a range in which the last lens and the image sensor 300 do not come into contact. Accordingly, the value of the L8S2_max_Sag to Sensor in the lens data may be smaller than the BFL of the optical system 1000, and the position of the filter 500 may move within a range that is not contact the last lens and the image sensor 300, respectively, and have good optical performance. That is, the distance between the critical point P4 and the image sensor 300 on the sixteenth surface S16 of the eighth lens 108 is the minimum, and may gradually increase toward the end of the effective region.

$$0.8 < BFL / L8S2\_max \_Sag to Sensor < 2 \qquad [ Equation 6 ]$$

In Equation 6, BFL means the distance (unit: mm) in the optical axis OA from the center of the sixteenth surface S16 of the eighth lens 108 to the image surface of the image sensor 300. When the optical system 1000 according to the embodiment satisfies Equation 6, the optical system 1000 may improve distortion aberration characteristics and may have good optical performance in the periphery portion of the FOV. Here, the L8S2 max_Sag value in the sensor-side direction may be the position of the critical point P4. Equation 6 may satisfy: 1≤BFL/L8S2_max_sag to Sensor<1.5.

$$5 < \vert L8S2\_max slope \vert < 65 \qquad [ Equation 7 ]$$

In Equation 7, L8S2_max slope means the maximum value (unit: degree) of the tangential angle measured on the sixteenth surface S16 on the sensor side of the eighth lens 108. In detail, in the sixteenth surface S16, the L8S2 max slope means an angle value (unit: degree) at a point having the largest tangential angle with respect to a virtual line extending in a direction perpendicular to the optical axis OA. When the optical system 1000 according to the embodiment satisfies Equation 7, the optical system 1000 may control the occurrence of lens flare. Preferably, Equation 7 may satisfy: 20≤|L8S2_max slope|≤40.

$$1 < Inf 82 < 2.4 \qquad [ Equation 8 ]$$

In Equation 8, Inf82 may mean a distance from the optical axis OA to the critical point P4 of the sixteenth surface 815 of the eighth lens 108. The Inf82 may be located within 1.8 mm±0.2 mm from the optical axis OA When the optical system 1000 according to the embodiment satisfies Equation 8, the influence on the slim rate of the optical system 1000 may be suppressed.

$$1 < CG 7 / G7\_min < 3 \qquad [ Equation 9 ]$$

Equation 9 sets the minimum distance G7_min between the distances between the seventh lens 107 and the eighth lens 108 and the distance CG7 between the seventh lens 107 and the eighth lens 108 based on the optical axis OA. When the optical system 1000 according to the embodiment satisfies Equation 9, the optical system 1000 may improve distortion aberration characteristics and may have good optical performance in the periphery portion of the FOV. Equation 9 may satisfy: 1<CG7/G7_min<2.

$$1 < CG 7 / EG 7 < 5 \qquad [ Equation 10 ]$$

In Equation 10, when the optical axis distance CG7 between the seventh and eighth lenses 107 and 108 and the optical axis distance EG8 at the end of the effective region between the seventh and eighth lenses 107 and 108 are satisfied, it may have good optical performance even in the center and periphery portions of the FOV. In addition, the optical system 1000 may reduce distortion and thus have improved optical performance. Preferably, Equation 10 may satisfy: 1<CG7/EG7<2.

$$0 < CG 1 / CG 7 < 1.5 \qquad [ Equation 11 ]$$

In Equation 11, when the optical axis distance CG1 between the first lens 101 and the second lens 102 and the optical axis distance CG7 between the seventh and eighth lenses 107 and 108 are satisfied, the optical system 1000 may improve aberration characteristics and control the size of the optical system 1000, for example, TTL reduction. Preferably, Equation 11 may satisfy: 0<CG1/CG7<1.

$$3 < CA\_L8S2 / CG 7 < 20 \qquad [ Equation 11 - 1 ]$$

In Equation 11-1, CA_L8S2 is the effective diameter of the largest lens surface, and is the size of the effective diameter of the sixteenth surface S16 of the eighth lens 108. When the optical system 1000 according to the embodiment satisfies Equation 11-1, the optical system 1000 may improve aberration characteristics and control TTL reduction. Preferably, Equation 11-1 may satisfy 1<CA_L8S2/CG7<10.

$$1 < CA\_L7S2 / CG 7 < 5 \qquad [ Equation 11 - 2 ]$$

Equation 11-2 may set the effective diameter CA_L7S2 of the fourteenth surface S14 of the seventh lens 107 and the optical axis distance CG7 between the seventh and eighth lenses 107 and 108. When the optical system 1000 according to the embodiment satisfies Equation 11-2, the optical system 1000 may improve aberration characteristics and control TTL reduction. Preferably, Equation 11-2 may satisfy: 2<CA_L7S2/CG7<4.5.

$$0 < CT 1 / CT 7 < 2 \qquad [ Equation 12 ]$$

In Equation 12, when the thickness CT1 of the first lens 101 in the optical axis OA and the thickness CT7 of the seventh lens 107 in the optical axis OA are satisfied, the optical system 1000 may have improved aberration characteristics. In addition, the optical system 1000 has good optical performance at a set FOV and may control TTL. Preferably, Equation 12 may satisfy: 0.5<CT1/CT7<1.5.

$$0 < CT 6 / CT 7 < 3 \qquad [ Equation 13 ]$$

In Equation 13, when the thickness CT6 of the sixth lens 106 in the optical axis OA and the thickness CT7 of the seventh lens 107 in the optical axis are satisfied, the optical system 1000 may alleviate the manufacturing precision of the seventh lens 107 and the eighth lens 108, and may improve optical performance of the center and periphery portions of the FOV. Preferably, Equation 13 may satisfy: 0<: CT6/CT7<1. The center thickness of the fifth, sixth, and seventh lenses may satisfy the following condition: CT7>(CT5+CT6). In addition, the center thickness of the first, sixth, seventh, and eighth lenses may satisfy the following condition: CT6<CT8<CT7.

$$0 < \vert L 7 R 2 / L 8 R 1 \vert < 2 \qquad [ Equation 14 ]$$

In Equation 14, L7R2 means the curvature radius (unit: mm) of the fourteenth surface S14 of the seventh lens 107 on the optical axis, and L8R1 means the curvature radius of the fifteenth surface S15 of the eighth lens 108 on the optical axis. When the optical system 1000 according to the embodiment satisfies Equation 14, the aberration characteristics of the optical system 1000 may be improved. Preferably, Equation 14 may satisfy: 1<|L7R2/L8R1|<2.

$$0 < ( CG 7 - EG 7 ) / ( CG 7 ) < 1 \qquad [ Equation 15 ]$$

When Equation 15 satisfies the center distance CG7 and the edge distance EG7 between the seventh and eighth lenses 107 and 108, the optical system 1000 may reduce distortion and have improved optical performance. When the optical system 1000 according to the embodiment satisfies Equation 15, the optical performance of the center and periphery portions of the FOV may be improved. Equation 15 may preferably satisfy: 0.1<(CG7−EG7)/(CG7)<0.8, Here, comparing the center distances CGs between the fourth, fifth, sixth, seventh, and eighth lenses, the following condition may satisfy: CG6<CG5<CG4<CG7.

$$1 < CA\_L1S1 / CA\_L2S2 < 2 \qquad [ Equation 16 ]$$

In Equation 16, CA_L1S1 means the effective diameter CA (clear aperture) of the first surface S1 of the first lens 101, and CA_L2S2 means the effective diameter of the fourth surface S4 of the second lens 102. When the optical system 1000 according to the embodiment satisfies Equation 1, the optical system 1000 may control light incident to the first lens group LG1 and may have improved aberration control characteristics. Equation 16 may preferably satisfy: 1<CA_L1S1/CA_L2S2<1.5.

$$1 < CA\_L7S2 / CA\_L3S1 < 5 \qquad [ Equation 17 ]$$

In Equation 17, CA_L3S1 means the effective diameter of the fifth surface S5 of the third lens 103, and CA_L7S2 means the effective diameter of the fourteenth surface S14 of the seventh lens 107. When the optical system 1000 according to the embodiment satisfies Equation 17, the optical system 1000 may control light incident to the second lens group LG2 and improve aberration characteristics. Preferably, Equation 17 may satisfy: 2<CA_L7S2/CA_L3S1<3.

$$0.5 < CA\_L3S2 / CA\_L4S1 < 1.5 \qquad [ Equation 18 ]$$

In Equation 18, when the effective diameter CA_L3S2 of the sixth surface S6 of the third lens 103 and the effective diameter CA_L4S1 of the seventh surface S7 of the fourth lens 104 are satisfied, a difference of effective diameters between the first and second lens groups LG1 and LG2 may be reduced, and light loss may, be suppressed. In addition, the optical system 1000 may improve chromatic aberration and control vignetting for optical performance. Preferably, Equation 18 may satisfy: 0.7<CA_L3S2/CA_L4S1<1.3.

$$0.1 < CA\_L5S2 / CA\_L7S2 < 1 \qquad [ Equation 19 ]$$

In Equation 19, when the effective diameter CA_L5S2 of the 10th surface S10 of the fifth lens 105 and the effective diameter CA_L7S2 of the fourteenth surface S14 of the seventh lens 107 are satisfied, a light path going to the second lens group LG2 may be set. Also, the optical system 1000 may improve chromatic aberration, Preferably, Equation 19 may satisfy: 0.4≤CA_L5S2/CA_L7S2≤0.8.

$$1 < CA\_L8S2 / CA\_L1S1 < 5 \qquad [ Equation 20 ]$$

In Equation 20, when the effective diameter CA_L8S1 of the sixteenth surface S16 of the eighth lens 109 and the effective diameter CA_L1S1 of the first surface S1 of the first lens 101 are satisfied, the effective diameters between the incident-side lens and the last lens may set. Accordingly, the optical system 1000 may set the FOV and a size of the optical system, Preferably, Equation 20 may satisfy: 2<CA_L8S2/CA_L1 S1<3.5.

$$5 < CG 3 / EG 3 < 15 \qquad [ Equation 21 ]$$

In Equation 21, when the distance CG3 between the third and fourth lenses 103 and 104 and the edge distance EG3 between the third and fourth lenses 103 and 104 are satisfied in the optical axis OA, the optical system 1000 may reduce chromatic aberration, improve aberration properties, and control vignetting for optical performance. Preferably, Equation 21 may satisfy: 7<CG3/EG3<13.

$$0 < CG 6 / EG 6 < 1 \qquad [ Equation 22 ]$$

In Equation 22, when the center distance CG6 and the edge distance EG6 between the sixth and seventh lenses 106 and 107 are satisfied, the optical system may have good optical performance even at the center portion and the periphery portion of the FOV, distortion occurrence may be prevented.

At least one of Equations 21 and 22 may further include at least one of Equations 22-1 to 22-6.

$$0 < CG 1 / EG 1 < 1 \qquad [ Equation 22 - 1 ]$$

$$0 < CG 2 / EG 2 < 0.5 \qquad [ Equation 22 - 2 ]$$

$$5 < CG 4 / EG 4 < 15 \qquad [ Equation 22 - 3 ]$$

$$1 < CG 5 / EG 5 < 3 \qquad [ Equation 22 - 4 ]$$

$$1 < ( CG 6 / EG 6 ) * n < 10 \qquad [ Equation 22 - 5 ]$$

$$1 < CG 7 / EG 7 < 3 \qquad [ Equation 22 - 6 ]$$

Here, n is the total number of lenses.

$$0 < G7\_max / CG 7 < 2 \qquad [ Equation 23 ]$$

In Equation 23, G7_Max means the maximum distance among the distances (unit: mm) between the seventh and eighth lenses 107 and 108. When the optical system 1000 according to the embodiment satisfies Equation 23, optical performance may be improved in the periphery portion of the FOV and distortion of aberration characteristics may be suppressed. Preferably, Equation 23 may satisfy: 0.5<G7_max/CG7<1.5.

$$0 < CT 6 / CG 7 < 2 \qquad [ Equation 24 ]$$

In Equation 24, when the thickness CT6 of the sixth lens 106 in the optical axis OA and the distance CG7 between the seventh and eighth lenses 107 and 108 on the optical axis OA are satisfied, the optical system 1000 may set the maximum optical axis distance CG7 and the center thickness of the sixth lens, and improve the optical performance of the periphery portion of the FOV. Preferably, Equation 24 may satisfy: 0<CT6/CG37<1

$$2 < CG 7 / CT 6 < 9 \qquad [ Equation 25 ]$$

In Equation 25, when the thickness CT6 of the sixth lens 106 in the optical axis OA and the distance CG7 between the seventh and eighth lenses 107 and 108 are satisfied, the optical system 1000 may reduce the size of the effective diameters of the sixth and seventh lenses 106 and 107 and the distance between the lenses, and improve the optical performance of the periphery portion of the FOV. Preferably, Equation 25 may satisfy: 4<CG7/CT6<8.

$$1 < CG 7 / CT 7 < 5 \qquad [ Equation 26 ]$$

When Equation 26 satisfies the thickness CT7 of the seventh lens 107 in the optical axis OA and the distance CG7 between the seventh and eighth lenses 107 and 108, the optical system 1000 may reduce the size of the effective diameter of the seventh lenses and the center distance between the seventh and eighth lenses, and improve the optical performance of the periphery portion of the FOV. Preferably, Equation 26 may satisfy: 2<CG7/CT7<4.

$$100 < \vert L 5 R 2 / CT 5 \vert < 300 \qquad [ Equation 27 ]$$

When Equation 27 satisfies the curvature radius L5R2 of the tenth surface S10 of the fifth lens 105 and the thickness CT5 of the fifth lens 105 in the optical axis, the optical system 1000 may control the refractive power of the fifth lens 105, and improve the optical performance of light incident to the second lens group LG2. Preferably, Equation 27 may satisfy: 200<|L5R2/CT5|<260. Preferably, the following condition may satisfy: L5R2>0.

$$2 < \vert L 5 R 1 / L 7 R 1 \vert < 10 \qquad [ Equation 28 ]$$

When Equation 28 satisfies the curvature radius L5R1 of the ninth surface S9 of the fifth lens 105 and the curvature radius L7R1 of the thirteenth surface S13 of the seventh lens 107, optical performance may be improved by controlling the shapes and refractive powers of the fifth and seventh lenses, and the optical performance of the second lens group LG2 may be improved. Preferably, Equation 28 may satisfy: 5<L5R1/L7R1<8. Preferably, the following condition may satisfy: L5R1<0.

$$0 < L 1 R 1 / L 1 R 2 < 1 \qquad [ Equation 29 ]$$

Equation 29 may set the curvature radii L1R1 and L1R2 of the object-side first surface S1 and the second surface S2 of the first lens 101, and when they are satisfied, the lens size and resolving power may be determined. Preferably, Equation 29 may satisfy: 0.3<L1R1/L1R2≤0.9. Preferably, the following conditions may satisfy: L1R1>0 and L1R2>0.

$$1 < L 2 R 2 / L 2 R 1 < 5 \qquad [ Equation 30 ]$$

Equation 30 may set the curvature radii L2R1 and L2R2 of the object-side third surface S3 and the fourth surface S4 of the second lens 102, and when these are satisfied, the resolving power of the lens may be determined. Preferably, Equation 30 may satisfy: 2<L2R2/L2R1≤3. Preferably, the following conditions may satisfy: L2R1>0 and L2R2>0.

At least one of Equations 28, 29, and 30 may include at least one of Equations 30-1 to 30-6 below, and resolution of each lens may be determined.

$$1 < L 3 R 1 / L 3 R 2 < 2 \qquad [ Equation 30 - 1 ]$$

$$1 < L 4 R 1 / L 4 R 2 < 3 \qquad [ Equation 30 - 2 ]$$

$$0 < \vert L 5 R 1 / L 5 R 2 \vert < 1 \qquad [ Equation 30 - 3 ]$$

$$0 \leq \vert L 6 R 1 / L 6 R 2 \vert < 1 \qquad [ Equation 30 - 4 ]$$

$$0 < L 7 R 1 / L 7 R 2 < 1 \qquad [ Equation 30 - 5 ]$$

$$3 < L 8 R 2 / L 8 R 1 < 7 \qquad [ Equation 30 - 6 ]$$

Preferably, the following conditions may satisfy: L4R1<0, L4R2<0, L5R1<0, and L6R1<0.

$$0 < CT\_Max / CG\_Max < 2 \qquad [ Equation 31 ]$$

In Equation 31, the largest thickness CT_max in the optical axis OA of each of the lenses and the maximum value CG_max of the air gaps or distances in the optical axis between the plurality of lenses are satisfied. In this case, the optical system 1000 has good optical performance at the set FOV and focal length, and the size of the optical system 1000, for example, the TTL may be reduced. Preferably, Equation 31 may satisfy: 0<CT_Max/CG_Max<=1.

$$0 < \sum CT / \sum CG < 2 \qquad [ Equation 32 ]$$

In Equation 32, ΣCT means the sum of thicknesses (unit: mm) in the optical axis OA of each of the plurality of lenses, and ΣCG means the sum of the distances (unit: mm) in the optical axis OA between two adjacent lenses in the plurality of lenses. When the optical system 1000 according to the embodiment satisfies Equation 32, the optical system 1000 has good optical performance at the set FOV and focal length, and reduces the size of the optical system 1000, for example, TTL may be reduced. Preferably, Equation 32 may satisfy: 0.5<ΣCT/ΣCG<1.

$$10 < \sum Index < 30 \qquad [ Equation 33 ]$$

In Equation 33, ΣIndex means the sum of the refractive indices at the d-line of each of the plurality of lenses. When the optical system 1000 according to the embodiment satisfies Equation 33, the TTL of the optical system 1000 may be controlled and resolution may be improved. Here, the average refractive index of the first to eighth lenses 101 to 108 may be 1.50 or more. Preferably, Equations 33 may satisfy: 10<ΣIndex<20 and 80<Σindex*n, where n is the total number of lenses.

$$10 < \sum Abb / \sum Index < 50 \qquad [ Equation 34 ]$$

In Equation 34, ΣAbbe means the sum of Abbe numbers of each of the plurality of lenses. When the optical system 1000 according to the embodiment satisfies Equation 34, the optical system 1000 may have improved aberration characteristics and resolution. An average Abbe number of the first to eight lenses 101 to 108 may be 45 or less. Preferably, Equation 34 may satisfy: 20<ΣAbb/ΣIndex<40.

$$0 < \vert Max\_distortion \vert < 5 \qquad [ Equation 35 ]$$

In Equation 35, Max_distortion means the maximum value of distortion in a region from the center (0.0F) to the diagonal end (1.0F) based on the optical characteristics detected by the image sensor 300, When the optical system 1000 according to the embodiment satisfies Equation 35, the optical system 1000 may improve distortion characteristics. Preferably, Equation 35 may satisfy: 1<|Max_distortion|<3.

$$0 < EG\_Max / CT\_Max < 3 \qquad [ Equation 36 ]$$

In Equation 36, CT_max means the thickest thickness (unit: mm) among the thicknesses in the optical axis OA of each of the plurality of lenses, and EG_Max means the maximum edge-side distance between two adjacent lenses. When the optical system 1000 according to the embodiment satisfies Equation 36, the optical system 1000 has a set FOV and focal length, and may have good optical performance in the periphery portion of the FOV. Preferably, Equation 36 may satisfy: 2<EG_Max/CT_Max<3.

$$0.5 < CA\_L1S 1 / CA\_min < 2 \qquad [ Equation 37 ]$$

In Equation 37, when the effective diameter CA_L1S1 of the first surface S1 of the first lens 101 and the minimum effective diameter CA_Min of the lens surfaces are satisfied, the light incident through the first lens 101 may be controlled and a slim optical system may be provided while maintaining optical performance. Preferably, Equation 37 may satisfy: 1<CA_L1 S1/CA_min<1.5.

$$1 < CA\_max / CA\_min < 5 \qquad [ Equation 38 ]$$

In Equation 38, CA_max means the largest effective diameter among the object-side and sensor-side surfaces of the plurality of lenses, and means the largest effective diameter among the effective diameters (unit: mm) of the first to sixteenth surfaces S1-S16. When the optical system 1000 according to the embodiment satisfies Equation 38, the optical system 1000 may provide a slim and compact optical system while maintaining optical performance. Preferably, Equation 38 may satisfy: 3<CA_max/CA_min<5.

$$1 < CA\_max / CA\_AVR < 3 \qquad [ Equation 39 ]$$

In Equation 39, the maximum effective diameter CA_max and the average effective diameter CA_AVR of the object-side and sensor-side surfaces of the plurality of lenses are set, and when these are satisfied, a slim and compact optical system may be provided. Preferably, Equation 39 may satisfy: 2<CA_max/CA_AVR<2.5.

$$0.1 < CA\_min / CA\_AVR < 1 \qquad [ Equation 40 ]$$

In Equation 40, the smallest effective diameter CA_min and the average effective diameter CA_AVR of the object-side surface and the sensor-side surface of the plurality of lenses may be set, and when these are satisfied, a slim and compact optical system may be provided. Preferably, Equation 40 may satisfy: 0.1<CA_min/CA_AVR≤0.8.

$$0.1 < CA\_max / ( 2 \times ImgH ) < 1 \qquad [ Equation 41 ]$$

In Equation 41, the largest effective diameter CA_max among the object-side surfaces and the sensor-side surfaces of the plurality of lenses and the distance ImgH from the center (0.0F) to the diagonal end (1.0F) of the image sensor 300 are set. When this is satisfied, the optical system 1000 has good optical performance in the center and periphery portions of the FOV, and may provide a slim and compact optical system. Here, the ImgH may be in the range of 4 mm to 15 mm. Preferably, Equation 41 may satisfy: 0.5≤CA_max/(2*ImgH)<1.

$$0.1 < TD / CA\_max < 1.5 \qquad [ Equation 42 ]$$

In Equation 42, TD is the maximum optical axis distance (unit: mm) from the object-side surface of the first lens group LG1 to the sensor-side surface of the second lens group LG2. For example, TD is a distance from the first surface S1 of the first lens 101 to the sixteenth surface S16 of the eighth lens 108 in the optical axis OA. When the optical system 1000 according to the embodiment satisfies Equation 42, a slim and compact optical system may be provided. Preferably, Equation 42 may satisfy: 0.1<TD/CA_max<0.8.

$$0 < / L 7 R 2 < 5 \qquad [ Equation 43 ]$$

In Equation 43, it is possible to set the total effective focal length F of the optical system 1000 and the curvature radius L7R2 of the fourteenth surface S14 of the seventh lens 107. When these are satisfied, the optical system 1000 may reduce the size of the optical system 1000, for example, TTL, Preferably, Equation 43 may satisfy: 0<F/L7R2<1.

Equation 43 may further include Equation 43-1 below.

$$2 < F / F \# < 8 \qquad [ Equation 43 - 1 ]$$

The F# may mean an F number. Preferably, Equation 43-1 may satisfy: 2<F/F#<5.

1<F/L8R2<5[ Equation43-2]

Equation 43-2 may set the total effective focal length F of the optical system 1000 and the curvature radius L8R2 of the sixteenth surface S16 of the eighth lens 108. Preferably, Equation 43-2 may satisfy: 2<F/L8R2<4.

$$1 < F / L 1 R 1 < 10 \qquad [ Equation 44 ]$$

In Equation 44, the curvature radius L1R1 of the first surface S1 of the first lens 101 and the total effective focal length F may be set, and when they are satisfied, the optical system 1000 1000 may be reduced in size, for example, TTL may be reduced. Preferably, Equation 44 may satisfy: 1<F/L1R1<5.

$$0 < EPD / L 7 R 2 < 5 \qquad [ Equation 45 ]$$

In Equation 45, EPD means the entrance pupil diameter (unit: mm) of the optical system 1000, and L8R2 means the curvature radius (unit: mm) of the sixteenth surface S16 of the eighth lens 108. When the optical system 1000 according to the embodiment satisfies Equation 45, the optical system 1000 may control overall brightness and may have good optical performance in the center and periphery portions of the FOV. Preferably, Equation 45 may satisfy: 1<EPD/L8R2<2.

Equation 45 may further include Equation 45-1 below.

$$1 < EPD / F \# < 3 \qquad [ Equation 45 - 1 ]$$

$$0.5 < EPD / L 1 R 1 < 8 \qquad [ Equation 46 ]$$

Equation 46 represents the relationship between the entrance pupil diameter of the optical system and the curvature radius of the first surface S1 of the first lens 101, and may control incident light. Preferably, Equation 46 may satisfy: 1<EPD/L1 R1<2.

$$0 < F 1 / F 2 < 2 \qquad [ Equation 47 ]$$

In Equation 47, the focal lengths F1 and F2 of the first and second lenses 101 and 102 may be set. Accordingly, resolving power may be improved by adjusting the refractive power of the incident light of the first and second lenses 101 and 102, and TTL may be controlled Preferably, Equation 47 may satisfy: 0<F1/F2<1, and may satisfy the following conditions: F1>0 and F2>0.

$$1 < F 13 / F < 5 \qquad [ Equation 48 ]$$

In Equation 48, since the composite focal length F13 of the first to third lenses and the total focal length F are set, the optical system 1000 may improve the resolving power by adjusting the refractive power of the incident light, and the TTL of the optical system 1000 may be controlled. Preferably, Equation 48 may satisfy: 1<F13/F<1.5.

$$1 < \vert F 48 / F 13 \vert < 4 \qquad [ Equation 49 ]$$

In Equation 49, the composite focal length F13 of the first to third lenses, that is, the focal length (unit: mm) of the first lens group and the composite focal length F48 of the fourth to eighth lenses, that is, the focal length of the second lens group may be set, and when this is satisfied, resolving power may be improved by controlling the refractive power of the first lens group and the refractive power of the second lens group, and the optical system may be provided in a slim and compact size. In addition, when Equation 49 is satisfied, the optical system 1000 may improve aberration characteristics such as chromatic aberration and distortion aberration. The above Equation 49 may preferably satisfy: 2<F48/F13|<3. Here, the following conditions may satisfy: F13>0 and F48<0.

$$0 < F 1 / F < 3 \qquad [ Equation 50 ]$$

In Equation 50, the total focal length F and the focal length of the first lens 101 may be set, and resolution may be improved. Equation 50 may satisfy: 0<F1/F<2, and the following condition may satisfy: F>0.

$$1 < F 2 / F < 5 ( where F 2 > 0 ) \qquad [ Equation 50 - 1 ]$$

$$1 < \vert F 3 / F 2 \vert < 5 ( where F 3 < 0 ) \qquad [ Equation 50 - 2 ]$$

$$3 < F 4 / F < 10 ( where F 4 > 0 ) \qquad [ Equation 50 - 3 ]$$

$$1 < \vert F 5 \vert / F < 5 ( where F 5 < 0 ) \qquad [ Equation 50 - 4 ]$$

$$1 < \vert F 6 \vert / F < 4 ( where F 6 < 0 ) \qquad [ Equation 50 - 5 ]$$

$$0 < F 7 / F < 1 ( where F 7 > 0 ) \qquad [ Equation 50 - 6 ]$$

$$0 < \vert F 8 \vert / F < 1 ( where F 8 < 0 ) \qquad [ Equation 50 - 7 ]$$

In Equations 50-1 to 50-7, F3, F4, F5, F6, F7, and F8 mean to the focal length (unit: mm) of the third, fourth, fifth, sixth, seventh, and eighth lenses 103, 104, 105, 106, 107, and 108, and when this is satisfied, the resolving power may be improved by controlling the refractive power of each lens, and the optical system may be provided in a slim and compact size.

$$0 < F 1 / F 13 < 2 \qquad [ Equation 51 ]$$

In Equation 51, the resolution of the first lens group may be adjusted by setting the focal length F1 of the first lens and the composite focal length F13 of the first to third lenses. Preferably, Equation 51 may satisfy: 1<F1/F13<2.

$$0 < F 1 / \vert F 48 \vert < 2 \qquad [ Equation 52 ]$$

In Equation 52, the size and resolution of the optical system may be adjusted by setting the focal length Ft of the first lens and the composite focal length F48 of the fourth to eighth lenses. Preferably, Equation 52 may satisfy: 0<F1/|F48|<1.

$$0 < \vert F 1 / F 4 \vert < 1 \qquad [ Equation 53 ]$$

in Equation 53, the refractive power of light incident to the first and second lens groups may be controlled, and the size and resolution of the optical system may be adjusted by setting the focal length F1 of the first lens and the focal length F4 of the fourth lens. Preferably, Equation 53 may satisfy: 0<|F1/F4<0.5.

$$2 mm < TTL < 20 mm \qquad [ Equation 54 ]$$

In Equation 54, Total track length (TTL) means the distance (unit: mm) in the optical axis OA from the apex of the first surface S1 of the first lens 101 to the image surface of the image sensor 300. Preferably, Equation 54 may satisfy: 5 mm<TTL<15 mm, and thus a slim and compact optical system may be provided.

$$2 mm < ImgH \qquad [ Equation 55 ]$$

Equation 55 sets the diagonal length (2*ImgH) of the image sensor 300 to exceed 4 mm, thereby providing an optical system with high resolution. Equation 55 may preferably satisfy: 4 mm≤Imgh≤15 mm or 6 mm≤Imgh≤12 mm.

Equation 55 may include at least one of Equations 55-1 to 55-4 below.

$$0 < \sum CT / Imgh / < 1 \qquad [ Equation 55 - 1 ]$$

$$0 < \sum CG / Imgh / < 1 \qquad [ Equation 55 - 2 ]$$

$$1 < \sum Index / Imgh < 3 \qquad [ Equation 55 - 3 ]$$

$$10 < \sum Abbe / Imgh < 50 \qquad [ Equation 55 - 4 ]$$

Equations 55-1 to 55-4 may establish a relationship between Imgh and the sum of center thicknesses of all lenses, the sum of center distances between lenses, the sum of refractive indices of all lenses, and the sum of Abbe numbers of all lenses. Accordingly, the resolving power and size of an optical system having an Imgh of 4 mm more or 6 mm or more may be adjusted.

$$BFL < 2.5 mm \qquad [ Equation 56 ]$$

In Equation 56, BFL (Back focal length) is less than 2.5 mm, so that the installation space of the filter 500 may be secured and the assembly of the components is improved through the gap between the image sensor 300 and the last lens and improve coupling reliability. Equation 56 may preferably satisfy: 0.8 mm<BFL<2 mm.

$$2 mm < F < 20 mm \qquad [ Equation 57 ]$$

In Equation 57, the total focal length F may be set according to the optical system, and preferably, may be satisfied: 5 mm<F<15.

$$FOV < 120 degrees \qquad [ Equation 58 ]$$

In Equation 58, a FOV means a field of view of the optical system 1000, and an optical system of less than 120 degrees may be provided. The FOV may be greater than 70 degrees, for example, in the range of 70 degrees to 100 degrees.

$$0.1 < TTL / CA\_max < 2 \qquad [ Equation 59 ]$$

In Equation 59, a slim and compact optical system may be provided by setting the largest effective diameter CA_max among the object-side and sensor-side surfaces of the plurality of lenses and TTL. Preferably, Equation 59 may satisfy: 0.5<TTL/CA_max<1.

$$0.5 < TTL / ImgH < 3 \qquad [ Equation 60 ]$$

Equation 60 may set the total optical axis length (TTL) of the optical system and the diagonal length (ImgH) from the optical axis in the image sensor 300. When the optical system 1000 according to the embodiment satisfies Equation 60, the optical system 1000 secures a BFL for the application of a relatively large-sized image sensor 300, for example, a large-sized image sensor 300 around 1 inch, and may have a smaller TTL and may have a high-definition implementation and a slim structure. Preferably, Equation 60 may satisfy: 0.8<TTL/ImgH<2. Preferably, the following conditions may satisfy: Imgh>TTL and 50<TTL*Imgh<90.

$$0.01 < BFL / ImgH < 0.5 \qquad [ Equation 61 ]$$

Equation 61 may set the distance in the optical axis between the image sensor 300 and the last lens and the length in the diagonal direction from the optical axis in the image sensor 300. When the optical system 1000 according to the embodiment satisfies Equation 61, the optical system 1000 may secure a BFL for applying a relatively large image sensor 300, for example, a large image sensor 300 of around 1 inch, and minimize the distance between the last lens and the image sensor 300, thereby having good optical characteristics at the center and periphery portion of the FOV. Preferably, Equation 61 may satisfy: 0.1≤BFL/Imgh≤0.3.

$$4 < TTL / BFL < 10 \qquad [ Equation 62 ]$$

Equation 62 may set (unit: mm) the total optical axis length TTL of the optical system and the optical axis distance BFL between the image sensor 300 and the last lens. When the optical system 1000 according to the embodiment satisfies Equation 62, the optical system 1000 secures the BFL and may be provided slim and compact. Equation 62 may satisfy: 6<TTL/BFL<10.

$$0.5 < F / TTL < 1.5 \qquad [ Equation 63 ]$$

Equation 63 may set the total focal length F and total optical axis length TTL of the optical system 1000. Accordingly, a slim and compact optical system may be provided. Equation 63 may preferably satisfy: 0.5<F/TTL<1.2.

$$0 < F \# / TTL < 0.5 \qquad [ Equation 63 - 1 ]$$

Equation 63-1 may set the F number F# and the total optical axis length TTL of the optical system 1000. Accordingly, a slim and compact optical system may be provided.

$$3 < F / BFL < 10 \qquad [ Equation 64 ]$$

Equation 64 may set the total focal length F of the optical system 1000 and the optical axis distance BFL between the image sensor 300 and the last lens. When the optical system 1000 according to the embodiment satisfies Equation 64, the optical system 1000 may have a set FOV, may have an appropriate focal length, and may provide a slim and compact optical system. In addition, the optical system 1000 may minimize the distance between the last lens and the image sensor 300, so that it may have good optical characteristics in the periphery portion of the FOV. Preferably, Equation 64 may satisfy: 4<F/BFL<8.

$$0.01 < F / ImgH < 3 \qquad [ Equation 65 ]$$

Equation 65 may set the total focal length F (unit: mm) of the optical system 1000 and the diagonal length (ImgH) from the optical axis in the image sensor 300. The optical system 1000 may have improved aberration characteristics by applying a relatively large image sensor 300, for example, a large image sensor 300 of around 1 inch. Preferably, Equation 65 may satisfy: 0.8≤F/ImgH<2.

$$1 < F / EPD < 5 \qquad [ Equation 66 ]$$

Equation 66 may set the total focal length F (unit: mm) of the optical system 1000 and the entrance pupil diameter. Accordingly, the overall brightness of the optical system may be controlled. Preferably, Equation 66 may satisfy: 1.5≤F/EPD<4.

$$0 < BFL / TD < 0.3 \qquad [ Equation 67 ]$$

In Equation 67, the optical axis distance BFL between the image sensor 300 and the last lens and the optical axis distance TD of the lenses are set, and when these are satisfied, the optical system 1000 may provide a slim and compact optical system. Preferably, Equation 67 may satisfy: 0<BFL/TD≤0.2. When BFL/TD exceeds 0.3, the size of the entire optical system increases because the BFL compared to TD is designed to be large, which makes it difficult to miniaturize the optical system, and since the distance between the eleventh lens and the image sensor increases, the amount of unnecessary light may increase through the eleventh lens and the image sensor, and as a result, there is problem in that resolving power is lowed, such as deterioration in aberration characteristics.

$$0 < EPD / Imgh / FOV < 0.2 \qquad [ Equation 68 ]$$

In Equation 68, the relationship between the size of the EPD, the length ImgH of ½ of the maximum diagonal length of the image sensor, and the FOV may be set. Accordingly, the overall size and brightness of the optical system may be controlled. Equation 68 may preferably satisfy: 0<EPD/Imgh/FOV<0.1.

$$10 < FOV / F \# < 55 \qquad [ Equation 69 ]$$

Equation 69 may establish a relationship between the FOV of the optical system and the F number. Equation 69 may preferably satisfy: 30<FOV/F<50.

$$0 < n 1 / n 2 < 1.5 \qquad [ Equation 70 ]$$

When the refractive indices n1 and n2 of the first and second lenses 101 and 102 of Equation 70 at the d-line satisfy the above range, the optical system may improve the resolution of the incident light. Preferably, it may satisfy: 0.5<n1/n2≤1.

$$0 < n 3 / n 4 < 1.5 \qquad [ Equation 71 ]$$

When the refractive indices n3 and n4 of the third and fourth lenses 103 and 104 of Equation 71 at the d-line satisfy the above range, the optical system may improve resolution of the incident light of the second lens group LG2. Preferably, Equation 71 may satisfy: 1<n3/n4<1.5.

$$0.8 < Inf 71 / Inf 72 < 1.5 \qquad [ Equation 72 ]$$

In Equation 72, the distance Inf71 from the optical axis OA to the critical point of the object-side surface S13 of the seventh lens 106 and the distance Inf72 from the optical axis OA to the critical point of the sensor-side surface S12 may be set, and when this is satisfied, the curvature aberration of the sixth lens may be controlled. Equation 72 may satisfy: 1≤Inf71/Inf72<1.5.

$$0 < Inf 81 / Inf 82 < 1 \qquad [ Equation 73 ]$$

In Equation 73, the distance Inf81 from the optical axis OA to the critical point of the fifteenth surface S15 of the eighth lens 108 and the distance Inf82 from the optical axis OA to the critical point of the sixteenth surface S16 of the eighth lens 108 may be set, and when this is satisfied, the curvature aberration of the eighth lens may be controlled. Equation 73 may satisfy: 0<Inf81/Inf82<0.5.

$$1 < Inf 72 / Inf 81 < 5 \qquad [ Equation 74 ]$$

In Equation 74, the distance Inf72 from the optical axis OA to the critical point of the sensor-side surface S14 of the seventh lens 107 and the distance Inf81 from the optical axis OA to the critical point of the object-side surface S15 of the eighth lens 108 may be set, and when this is satisfied, the satisfaction aberrations of the seventh and eighth lenses may be controlled. Equation 74 may satisfy: 2<Inf72/Inf81<4.

$$5 < ( TTL / Imgh ) * n < 15 \qquad [ Equation 75 ]$$

Preferably, Equation 79 may satisfy: 8<(TTL/Imgh)*n<10

$$4 < ( F / Imgh ) * n < 14 \qquad [ Equation 76 ]$$

Preferably, Equation 80 may satisfy: 6<(F/Imgh)*n<11.

$$25 < ( TD\_LG2 / TD\_LG1 ) * n < 55 \qquad [ Equation 77 ]$$

$$15 < ( CT\_Max + CG\_Max ) * n < 30 \qquad [ Equation 78 ]$$

$$40 < ( FOV * TTL ) / n < 150 \qquad [ Equation 79 ]$$

$$( TTL * n ) < FOV \qquad [ Equation 80 ]$$

$$( v 3 * n 3 ) < ( v 1 * n 1 ) \qquad [ Equation 81 ]$$

In Equations 75 to 81, n is the total number of lenses, and the relationships between the optical axis distance TD_LG1 of the first lens group LG1 the optical axis distance TD_LG2 of the second lens group LG2, the maximum center thickness CT_Max of the lenses, the maximum center distances CG_Max, FOV, TTL, and like may be set according to the total number of lenses. Accordingly, it is possible to control chromatic aberration, resolving power, size, and the like of an optical system having nine or less lenses.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 82 ]$$

In Equation 82, Z is Sag and may mean a distance in the optical axis direction from an arbitrary position on the aspheric surface to the apex of the aspheric surface. The Y may mean a distance in a direction perpendicular to the optical axis from an arbitrary position on the aspheric surface to the optical axis. The c may mean the curvature of the lens, and K may mean the conic constant. Also, A, B, C, D, E, and F may mean aspheric constants.

The optical system 1000 according to the embodiment may satisfy at least one or two or more of Equations 1 to 81. In this case, the optical system 1000 may have improved optical characteristics. In detail, when the optical system 1000 satisfies at least one or two or more of Equations 1 to 81, the optical system 1000 has improved resolution and may improve aberration and distortion characteristics. In addition, the optical system 1000 may secure a BFL for applying the large-size image sensor 300, and may minimize the distance between the last lens and the image sensor 300 and thus have good optical performance in the center and periphery portions of the FOV. In addition, when the optical system 1000 satisfies at least one of Equations 1 to 81, it may include a relatively large image sensor 300, have a relatively small TTL value, and may provide a slimmer and more compact optical system and a camera module having the same.

In the optical system 1000 according to the embodiment, the distance between the plurality of lenses 100 may have a value set according to the region.

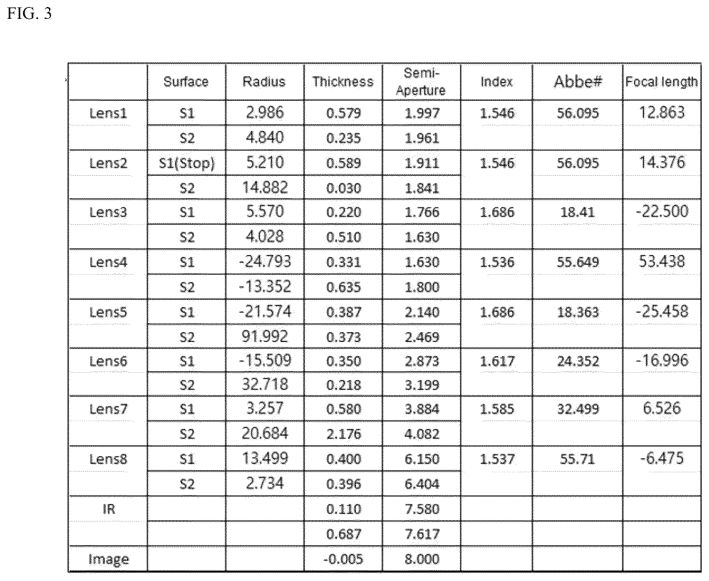

FIG. 3 is an example of lens data according to an embodiment having the optical system of FIG. 1.

As shown in FIG. 3, the optical system according to the embodiment represents the curvature radius of the first to eighth lenses 101 to 108 on the optical axis OA, the center thickness CT of the lens, and the center distances CG between the lenses, refractive index at d-line (588 nm), Abbe number and effective radius (Semi-aperture), and focal length.

The sum of refractive indices of the plurality of lenses 100 is greater than 10, the sum of the Abbe number is greater than 300, and the sum of center thicknesses of all lenses is 5 mm or less, for example, in the range of 2 mm to 5 mm. A sum of center distances between the first to eighth lenses in the optical axis may be 6 mm or less, for example, in a range of 2 mm to 6 mm, and may be greater than the sum of center thicknesses of the lenses. In addition, the average value of the effective diameter of each lens surface of the plurality of lenses 100 is 8 mm or less, for example, in the range of 3 mm to 8 mm. The average of the center thickness of each lens may be less than 1 mm, for example in the range of 0.2 mm to 0.7 mm. The sum of the effective diameters of each lens surface of the plurality of lenses 100 is the sum of the effective diameters from the first surface S1 to the sixteenth surface S16, and may be less than 120 mm, for example, in the range of 80 mm to 110 mm.

As shown in FIG. 4, in the embodiment, at least one or all lens surfaces of a plurality of lenses may include an aspherical surface having a 30th order aspherical surface coefficient. For example, the first to eighth lenses 101 to 108 may include lens surfaces having 30th order aspheric coefficients from the first surface S1 to the sixteenth surface S16. As described above, an aspherical surface having a 30th order aspheric coefficient (a value other than “0”) may change the aspherical shape of the peripheral portion particularly greatly, so that the optical performance of the peripheral portion of the FOV may be well corrected.

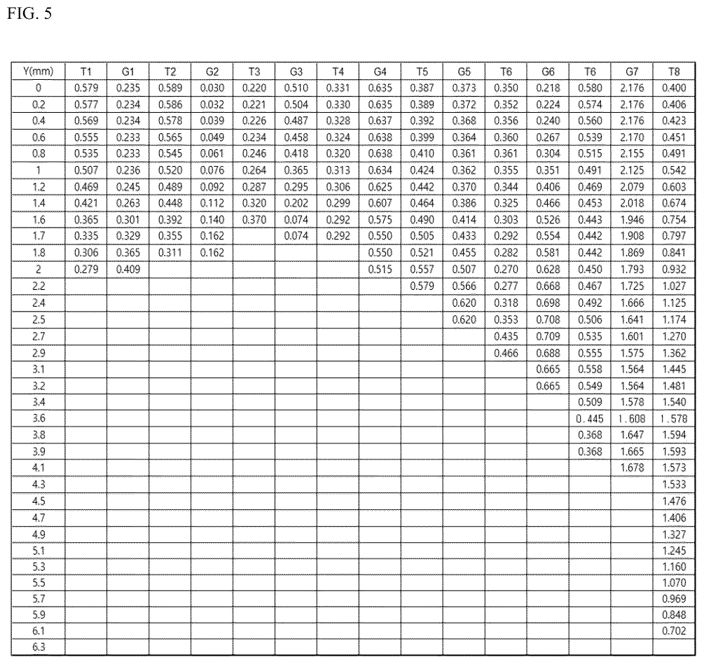

As shown in FIG. 5, the first to eighth thicknesses T1 to T8 of the first to eighth lenses 101 to 108 may be represented at distances of 0.1 mm or more in a direction Y from the center to the edge of each lens, the distance between adjacent lenses may be expressed at distances of 0.1 mm or more in a direction from the center to the edge with respect to a first distance G1 between the first and second lenses, a second distance G2 between the second and third lenses, a third distance G3 between the third and fourth lenses, a fourth distance G4 between the fourth and fifth lenses, a fifth distance G5 between the fifth and sixth lenses, a sixth distance G6 between the sixth and seventh lenses, a seventh distance G7 between the seventh and eighth lenses.

The maximum thickness of the first thickness T1 may have a difference from the minimum thickness of 1.5 times or more, for example, 1.5 to 4 times. The maximum distance of the first distance G1 may be 1.1 times or more, for example, 1.1 times to 2.5 times greater than minimum distance. The maximum thickness of the second thickness T2 may be 1.1 times or more, for example, 1.1 times to 2.5 times the minimum thickness. The maximum distance of the second distance G2 may be 3 times or more, for example, 3 times to 10 times greater than the minimum distance. The maximum thickness of the third thickness T3 may be 1.1 times or more, for example, 1.1 times to 3 times greater than the minimum thickness. The maximum distance of the third distance G3 may have a difference from the minimum distance of 4 times or more, for example, 4 times to 10 times. The maximum thickness of the fourth thickness T4 T3 may have a difference from the minimum thickness of one or more times, for example, 1 to 2.2 times. The maximum distance of the fourth distance G4 may have a difference from the minimum distance of one or more times, for example, 1 to 2.5 times. The maximum thickness of the fifth thickness T5 may have a difference from the minimum thickness of 1.1 times or more, for example, 1 to 3 times. The maximum distance of the fifth distance G5 may have a difference from the minimum distance of 1.1 times or more, for example, 1.1 times to 3 times. The maximum thickness of the sixth thickness T6 may have a difference from the minimum thickness of 11 times or more, for example, 1.1 times to 3 times. The maximum distance of the sixth distance G6 may have a difference from the minimum distance of 2 times or more, for example, 2 to 10 times. The maximum thickness of the seventh thickness T7 may have a difference from the minimum thickness of 1.1 times or more, for example, 1.1 times to 2.5 times. The maximum distance of the seventh distance G7 may have a difference from the minimum distance of 1.1 times or more, for example, 1.1 times to 2 times. The maximum thickness of the eighth thickness T8 may have a difference from the minimum thickness of 2 times or more, for example, 2 to 5 times. The optical system may be provided in a slim and compact size by using the first to eighth thicknesses T1 to T8 and the first to seventh distances G1 to G7.

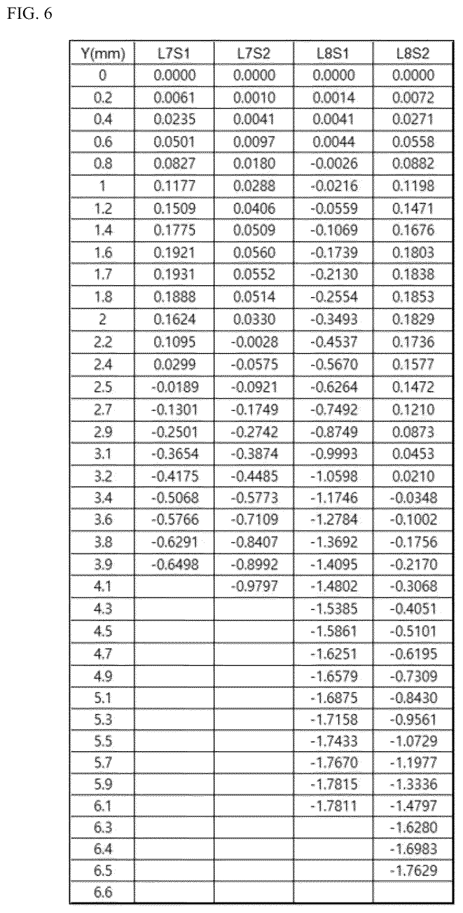

FIG. 6 may be represented by a height (S ag value) from a straight line in the Y-axis direction orthogonal to the center of an object-side surface L7S1 and a sensor-side surface L7S2 of a seventh lens 107, an object-side surface L8S1 and a sensor-side surface L8S2 of an eighth lens 108 according to an embodiment of the invention to a lens surface at distances of 0.1 mm or more, and FIG. 11 is a graph showing FIG. 5. As shown in FIGS. 2, 6, and 11, the object-side surface L7S1 and the sensor-side surface L7S2 of the seventh lens 107 have the critical points P1 and P2 in a region at 2.5 mm or less from the optical axis, and it may be seen that the Sag value of the object-side surface L7S1 protrudes in the sensor-side direction more than the Sag value of the sensor-side surface L7S2. And, in the sensor-side direction, the Sag value of L8S2, which is the sensor-side surface of the eighth lens 108, may be greater than the Sag value of the object-side surface L8S1, and as shown in FIGS. 2 and 11, it may be seen that the critical point P3 of the object-side surface of the eighth lens is disposed closer to the optical axis than the other critical points P1, P2, and P4.

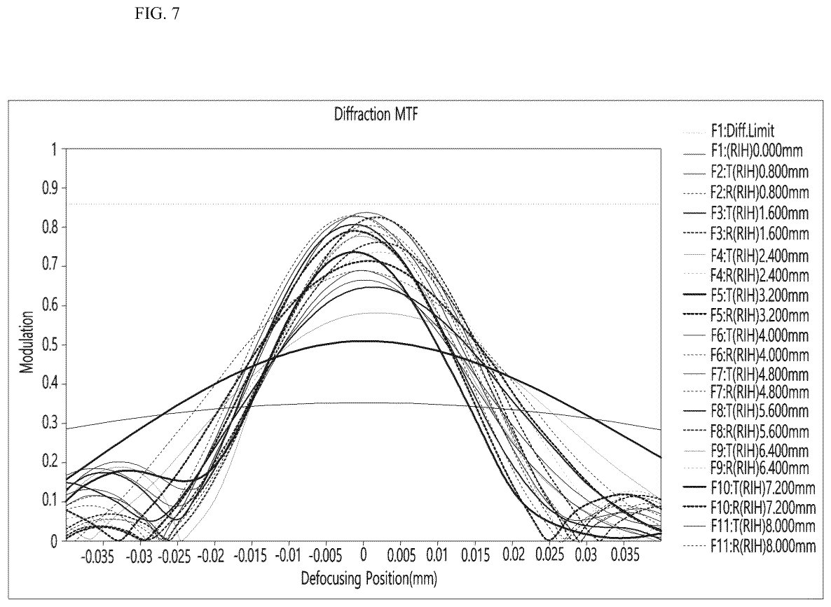

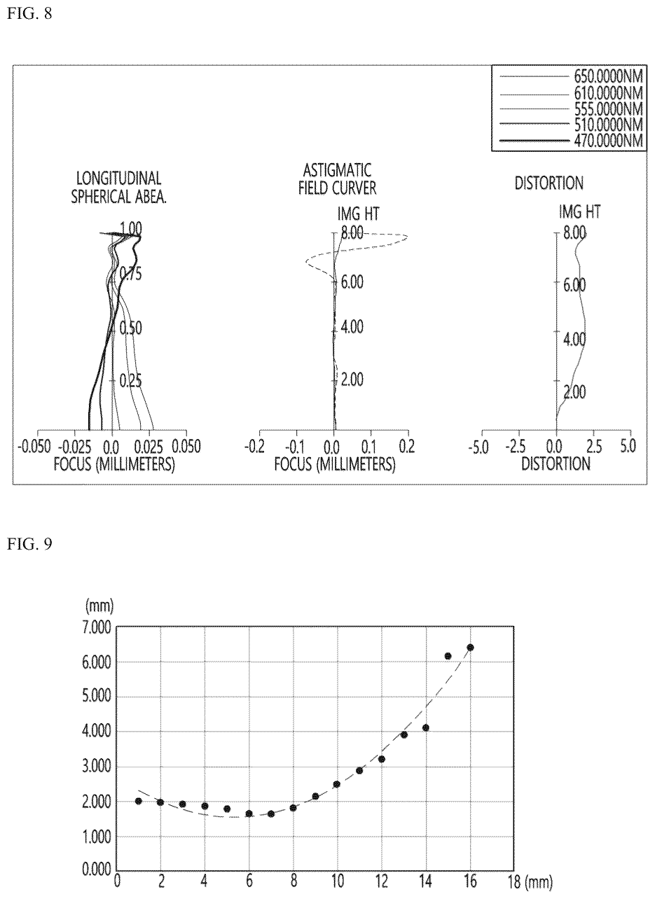

FIG. 7 is a graph showing diffraction MTF characteristics of an optical system according to an embodiment of the invention, and FIG. 8 is a graph showing aberration characteristics of an optical system according to an embodiment of the invention.

As shown in FIGS. 7 and 8, in the aberration graph of the optical system according to the embodiment, it is a graph in which spherical aberration, astigmatic field curves, and distortion are measured from left to right, the X-axis may mean a focal length (mm) and distortion (%), and the Y-axis may mean the height of an image. In addition, a graph of spherical aberration is a graph of light in a wavelength band of about 470 nm, about 510 nm, about 555 nm, about 610 nm, and about 650 nm, and a graph of astigmatism and distortion is a graph of light in a wavelength band of 555 nm. In the aberration diagram of FIG. 8, it may be interpreted that the aberration correction function is better as each curve approaches the Y-axis. Referring to FIG. 8, in the optical system 1000 according to the embodiment, it may be seen that measurement values are adjacent to the Y-axis in almost all regions. That is, the optical system 1000 according to the embodiment may have improved resolution and good optical performance not only at the center portion of the FOV but also at the periphery portion. As confirmed in the above embodiment, the lens system of the embodiment according to the invention has a lens configuration of 9 or less, for example, 8 lenses, and is compact and lightweight, and at the same time, spherical aberration, astigmatism, distortion aberration, chromatic aberration, and coma aberration are all good. Since it may be calibrated and implemented with high resolution, it may be used by being embedded in the optical device of the camera.

FIG. 9 illustrates a quadratic function closest to a curve passing through the ends of effective regions of the object-side surface and the sensor-side surface of each lens in the optical system according to the embodiment. Data from the end of the effective region of the object-side surface of the first lens to the end of the effective region of the sensor-side surface of the eighth lens may be represented by approximating a quadratic function.

A quadratic function may have the following relationship.

$$y = 0.04 {x}^{2} - 0.4459 x + k 1 \qquad [ Function 1 ]$$

The k1 is a coefficient for setting the position in the y-axis direction, and may be set to 2.7±0.2, In addition, the fitting coefficient (R²) that may be expressed by approximating the lens data as a function in the above function 1 is 0.95 or more, and the closer to 1, the closer it may be to the function.

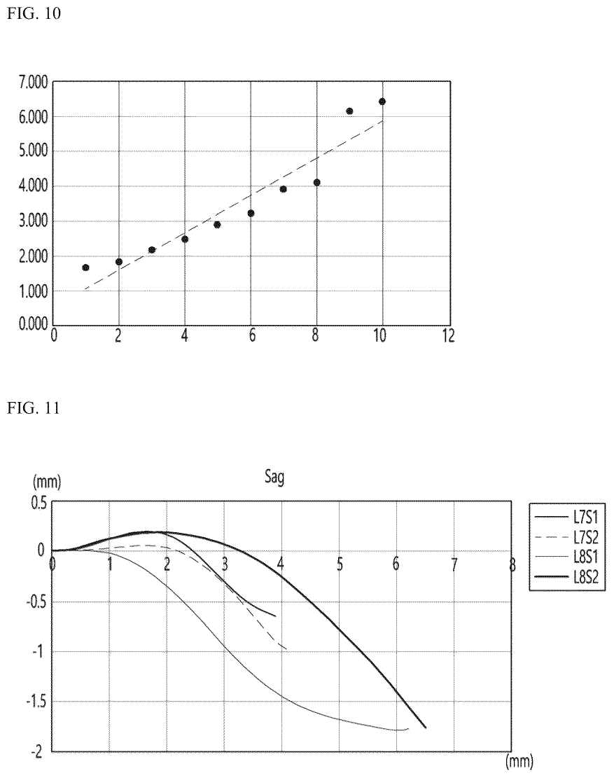

FIG. 10 illustrates a linear function closest to a straight-line from the minimum effective diameter to the maximum effective diameter in the optical system according to the embodiment. For example, data from the end of the effective region of the object-side surface of the fourth lens to the end of the effective region of the sensor-side surface of the eighth lens may be expressed by approximating a linear function.

$$y = 0.0531 x + k 2 \qquad [ Function 2 ]$$

The k2 is a coefficient for setting the position in the y-axis direction, and may be set to 0.5±0.05. In addition, the fitting coefficient (R²) that may be expressed by approximating the lens data as a function in the function 2 is 0.90 or more, and the closer to 1, the closer to the function.

As shown in FIGS. 9 and 10, a quadratic function connecting the ends of the effective region of each lens and the end of the effective region of the lens having the minimum effective diameter and the end of the effective region of the lens having the maximum effective diameter are set as a linear function may be given, and the size of the optical system may be optimally set.

Table 1 relates to the items of the above-mentioned equations in the optical system 1000 according to the embodiment, and relates TTL, BFL, total effective focal length F value of the optical system 1000, ImgH, focal lengths (F1, F2, F3, F4, F5, F6, FT F8) of each of the first to eighth lenses, edge thickness, edge distances, composite focal length, and the like.

TABLE 1

| Items | Embodiment | Items | Embodiment |
|---|---|---|---|
| F | 7.847 | ET1 | 0.252 |
| F1 | 12.863 | ET2 | 0.250 |
| F2 | 14.376 | ET3 | 0.339 |
| F3 | −22.500 | ET4 | 0.250 |
| F4 | 53.438 | ET5 | 0.250 |
| F5 | −25.458 | ET6 | 0.325 |
| F6 | −16.996 | ET7 | 0.250 |
| F7 | 6.526 | ET8 | 0.480 |
| F8 | −6.475 | EG1 | 0.408 |
| F13 | 9.254 | EG2 | 0.177 |
| F48 | −22.147 | EG3 | 0.050 |
| Inf71 | 1.7 | EG4 | 0.227 |
| Inf72 | 1.6 | EG5 | 0.284 |
| Inf81 | 0.5 | EG6 | 0.431 |
| Inf82 | 1.8 | EG7 | 1.371 |
| FOV | 90.000 | ΣIndex | 12.739 |
| EPD | 3.983 | ΣAbbe | 317.272 |
| BFL | 1.188 | ΣCT | 3.436 |
| TD | 8.008 | ΣCG | 4.176 |
| ImgH | 8.000 | CT_Max | 0.589 |
| SD | 7.194 | CA_Max | 12.807 |
| F# | 1.970 | TTL | 8.800 |

Table 2 is for the result values for Equations 1 to 42 described above in the optical system 1000 of FIG. 1. Referring to Table 2, it may be seen that the optical system 1000 satisfies at least one, two or more, or three or more of Equations 1 to 42. In detail, it may be seen that the optical system 1000 according to the embodiment satisfies all of Equations 1 to 42. Accordingly, the optical system 1000 may improve optical performance and optical characteristics at the center portion and the periphery portion of the FOV.

TABLE 2

| | |
|---|---|
| Equations | Embodiment |

| | | |
|---|---|---|
| 1 | 0 < CT1 / CT2 < 1.5 | 0.984 |
| 2 | 0 < CT3 / ET3 < 1.5 | 0.649 |
| 3 | 0 < ET8 / CT8 < 3 | 1.199 |
| 4 | 1.60 < n3 | 1.686 |
| 5 | 0.5 < L8S2_max_Sag to Sensor < 1.5 | 1.003 |
| 6 | 0.8 < BFL / L8S2_max_Sag to Sensor < 2 | 1.185 |
| 7 | 5 < \|L8S2_max slope\| < 65 | 36.000 |
| 8 | 1.5 < Inf82 < 2.4 | 1.800 |
| 9 | 1 < CG7 / G7_min < 3 | 1.391 |
| 10 | 1 < CG7 / EG7 < 5 | 1.586 |
| 11 | 0 < CG1 / CG7 < 1.5 | 0.108 |
| 12 | 0 < CT1 / CT7 < 2 | 1.000 |
| 13 | 0 < CT6 / CT7 < 3 | 0.604 |
| 14 | 0 < \| L7R2 / L8R1 \| < 2 | 1.532 |
| 15 | 0 < (CG7 − EG7) / (CG7) < 1 | 0.370 |
| 16 | 1 < CA_L1S1 / CA_L3S2 < 2 | 1.085 |
| 17 | 1 < CA_L7S2 / CA_L3S1 < 5 | 2.312 |
| 18 | 0.5 < CA_L3S2 / CA_L4S1 < 1.5 | 1.000 |
| 19 | 0.1 < CA_L5S2 / CA_L7S2 < 1 | 0.605 |
| 20 | 1 < CA_L8S2/CA_L1S1 < 5 | 3.207 |
| 21 | 5 < CG3 / EG3 < 15 | 10.216 |
| 22 | 0 < CG6 / EG6 < 1 | 0.506 |
| 23 | 0 < G7_max / CG7 < 2 | 1.000 |
| 24 | 0 < CT6 / CG7 < 2 | 0.161 |
| 25 | 2 < CG6 / CT6 < 9 | 6.216 |
| 26 | 1 < CG7 / CT7 < 5 | 3.754 |
| 27 | 100 < \|L5R2 / CT5\| < 300 | 237.456 |
| 28 | 2 < \|L5R1 / L7R1\| < 10 | 6.623 |
| 29 | 0 < L1R1/L1R2 < 1 | 0.617 |
| 30 | 1 < L2R2/L2R1 < 5 | 2.856 |
| 31 | 0 < CT_Max / CG_Max < 2 | 0.271 |
| 32 | 0 < ΣCT / ΣCG < 2 | 0.823 |
| 33 | 10 < ΣIndex < 30 | 12.739 |
| 34 | 10 < ΣAbb / ΣIndex < 50 | 24.906 |
| 35 | 0 < \|Max_distoriton\| < 5 | 2.000 |
| 36 | 0 < EG_Max / CT_Max < 3 | 2.330 |
| 37 | 0.5 < CA_L1S1 / CA_min < 2 | 1.225 |
| 38 | 1 < CA_max / CA_min < 5 | 3.929 |
| 39 | 1 < CA_max / CA_AVR < 3 | 2.240 |
| 40 | 0.1 < CA_min / CA_AVR < 1 | 0.570 |
| 41 | 0.1 < CA_max / (2*ImgH) < 1 | 0.800 |
| 42 | 0.1 < TD / CA_max < 1.5 | 0.625 |

Table 3 is for the result values for Equations 43 to 81 described above in the optical system 1000 of FIG. 1. Referring to Table 3, the optical system 1000 may satisfy at least one or two or more of Equations 1 to 42 and at least one, two or more, or three or more of Equations 43 to 81. In detail, it may be seen that the optical system 10010 according to the embodiment satisfies all of Equations 1 to 81, Accordingly, the optical system 1000 may improve optical performance and optical characteristics at the center portion and the periphery portion of the FOV.

TABLE 3

| | |
|---|---|
| Equations | Embodiment |

| | | |
|---|---|---|
| 43 | 0 < F / L7R2 < 5 | 0.379 |
| 44 | 1 < F / L1R1 < 10 | 2.627 |
| 45 | 0 < EPD / L8R2 < 5 | 1.457 |
| 46 | 0.5 < EPD / L1R1 < 8 | 1.334 |
| 47 | 0 < F1 / F2 < 2 | 0.895 |
| 48 | 0 < F13 / F < 2 | 1.179 |
| 49 | 1 < \|F48 / F13\| < 4 | 2.393 |
| 50 | 0 < F1/F < 3 | 1.639 |
| 51 | 0 < F1/F13 < 2 | 1.390 |
| 52 | 0 < \| F1/F48 \| < 2 | 0.581 |
| 53 | 0 < \|F1/F4\| < 1 | 0.241 |
| 54 | 2 < TTL < 20 | 8.800 |
| 55 | 2 < ImgH | 8.000 |
| 56 | BFL < 2.5 | 1.188 |
| 57 | 2 < F < 20 | 7.847 |
| 58 | FOV < 120 | 90.000 |
| 59 | 0.1 < TTL / CA_max < 2 | 0.687 |
| 60 | 0.5 < TTL / ImgH < 3 | 1.100 |
| 61 | 0.01 < BFL / ImgH < 0.5 | 0.149 |
| 62 | 4 < TTL / BFL < 10 | 7.406 |
| 63 | 0.5 < F / TTL < 1.5 | 0.892 |
| 64 | 3 < F / BFL < 10 | 6.604 |
| 65 | 0 < F / ImgH < 3 | 0.981 |
| 66 | 1 < F / EPD < 5 | 1.970 |
| 67 | 0 < BFL/TD < 0.3 | 0.148 |
| 68 | 0 < EPD/Imgh/FOV < 0.2 | 0.006 |
| 69 | 10 < FOV / F# < 55 | 45.687 |
| 70 | 0 < n1/n2 < 1.5 | 1.000 |
| 71 | 0 < n3/n4 < 1.5 | 1.098 |
| 72 | 0.8 < Inf71/Inf72 < 1.5 | 1.063 |
| 73 | 0.8 < Inf81/Inf82 < 1.5 | 0.278 |
| 74 | 0.8 < Inf72/Inf82 < 1.5 | 3.200 |
| 75 | 5 < (TTL/Imgh)*n < 15 | 8.800 |
| 76 | 4 < (F/Imgh)*n < 14 | 7.847 |
| 77 | 25 < (TD_LG2/TD_LG1)*n < 55 | 28.298 |
| 78 | 15 < (CT_Max + CG_Max)*n < 30 | 22.113 |
| 79 | 40 < (FOV*TTL)/n < 150 | 99.000 |
| 80 | (TTL*n) < FOV | Satisfaction |
| 81 | (v3*n3) < (v1*n1) | Satisfaction |

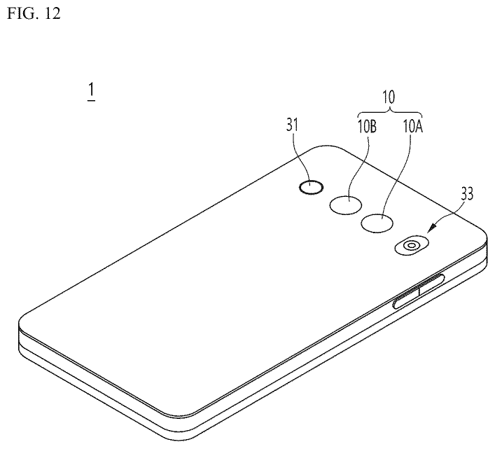

FIG. 12 is a diagram illustrating that a camera module according to an embodiment is applied to a mobile terminal. Referring to FIG. 12, the mobile terminal 1 may, include a camera module 10 provided on the rear side. The camera module 10 may include an image capturing function. In addition, the camera module 10 may include at least one of an auto focus function, a zoom function, and an OIS function.

The camera module 10 may process a still image or video frame obtained by the image sensor 300 in a shooting mode or a video call mode. The processed image frame may be displayed on a display unit (not shown) of the mobile terminal 1 and may be stored in a memory (not shown). In addition, although not shown in the drawings, the camera module may be further disposed on the front side of the mobile terminal 1.

For example, the camera module 10 may include a first camera module 10A and a second camera module 10B. At this time, at least one of the first camera module 10A and the second camera module 10B may include the above-described optical system 1000. Accordingly, the camera module 10 may have a slim structure and may have improved distortion and aberration characteristics. In addition, the camera module 10 may have good optical performance even in the center and periphery portions of the FOV.

In addition, the mobile terminal 1 may further include an auto focus device 31. The auto focus device 31 may include an auto focus function using a laser. The auto-focus device 31 may be mainly used in a condition in which an auto-focus function using an image of the camera module 10 is degraded, for example, a proximity of 10 m or less or a dark environment. The autofocus device 31 may include alight emitting unit including a vertical cavity surface emitting laser (VCSEL) semiconductor device and a light receiving unit such as a photodiode that converts light energy into electrical energy. In addition, the mobile terminal 1 may further include a flash module 33. The flash module 33 may include a light emitting element emitting light therein. The flash module 33 may be operated by a camera operation of a mobile terminal or a user's control.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention. Although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1-24. (canceled)

25. An optical system comprising:
first to eighth lenses disposed along an optical axis in a direction from an object side to a sensor side,
wherein the first lens has a positive (+) refractive power on the optical axis and has a meniscus shape that is convex toward the object side,
wherein the eighth lens has negative (−) refractive power on the optical axis and has a meniscus shape that is convex toward the object side.
wherein an object-side surface of the seventh lens has a critical point,
wherein a sensor-side surface of the eighth lens has a critical point,
wherein an effective diameter of a sensor-side surface of the third lens is CA_L3S2,
wherein an effective diameter of an object-side surface of the fourth lens is CA_L4S1,
wherein a maximum thickness among center thicknesses of the first to eighth lenses is CT_Max,
wherein a maximum distance among distances between the first to eighth lenses is CG_Max,
wherein the following Equations satisfy:
$$0.5 < CA\_L3S2 / CA\_LAS1 < 1.5 \qquad Equation$$
$$0 < CT\_Max / CG\_Max < 1 , \qquad Equation$$
and
wherein a sum ΣCT of center thicknesses of the lenses of the first and second lens groups and sum ΣCG of distances between two adjacent lenses are satisfy the following equation:
$$0 < \sum CT / \sum CG < 1.$$

26. The optical system of claim 25, wherein each of a sensor-side surface of the seventh lens and an object-side surface of the eighth lens has a critical point, and
wherein the critical point of the object-side surface of the eighth lens is located closer to the optical axis than the critical points of the object-side surface and the object-side surface of the seventh lens.

27. The optical system of claim 25, wherein an optical axis distance from a center of an object-side surface of the first lens to a surface of an image sensor is TTL,
wherein ½ of a maximum diagonal length of the image sensor is Imgh,
wherein a field of view of the optical system is FOV, and
wherein the following Equations satisfy:
$$5 < ( TTL / Imgh ) * n < 15 \qquad Equation$$
Equation: (TTL*n)<FOV, where n may be a total number of lenses.

28. The optical system of claim 25, wherein when an entrance pupil diameter of the optical system is EPD and a curvature radius of an object-side surface of the first lens on the optical axis is L1R1,
wherein the following Equation satisfies: 1<EPD/L1R1<2.

29. The optical system of claim 25, wherein the following equations satisfies:
$$Imgh < TTL \qquad Equation$$
$$50 < TTL * Imgh < 90 \qquad Equation$$
(An optical axis distance from a center of an object-side surface of the first lens to a surface of an image sensor is TTL, and ½ of a maximum diagonal length of the image sensor is Imgh.).

30. The optical system of claim 25, wherein a normal line perpendicular to a tangent line passing through an arbitrary point on the sensor-side surface of the eighth lens has a maximum first angle with respect to the optical axis,
wherein the first angle satisfies in a range of 20 degrees to 40 degrees,
wherein a normal line perpendicular to a tangent line passing through an arbitrary point on an object-side surface of the eighth lens has a maximum second angle with respect to the optical axis, and
wherein a difference between the first angle and the second angle is less than 10 degrees.

31. The optical system of claim 30, wherein a normal line perpendicular to a tangent line passing through an arbitrary point on a sensor-side surface of the seventh lens has a maximum third angle with respect to the optical axis,
wherein a difference between the first angle and the third angle is less than 10 degrees,
wherein a normal line perpendicular to a tangent line passing through an arbitrary point on the object-side surface of the seventh lens has a maximum fourth angle with respect to the optical axis, and
wherein a difference between the first angle and the fourth angle is 10 degrees or less.

32. The optical system of claim 25, wherein the second, third, and seventh lenses may have a meniscus shape that is convex toward the object side on the optical axis, and
wherein the fourth lens has a meniscus shape that is convex toward the object side on the optical axis.

33. The optical system of claim 25, wherein a maximum of effective diameters of an object-side surfaces and a sensor-side surface of each of the first to eighth lenses is CA_Max,
wherein ½ of a maximum diagonal length of an image sensor is Imgh, and
wherein the following Equation satisfies: 0.1<CA_max/(2*ImgH)<1.

34. The optical system of claim 25, wherein the following Equation satisfies:
$$( v 3 * n 3 ) < ( v 1 * n 1 )$$
(v1 is an Abbe number of the first lens, v3 is an Abbe number of the third lens, n1 is a refractive index of the first lens, and n3 is a refractive index of the third lens.).

35. An optical system comprising:
a first lens group having a plurality of lenses disposed on an object side;
a second lens group having a plurality of lenses disposed on a sensor side of the first lens group; and
an aperture stop disposed around an object-side surface of any one of the lenses of the first lens group,
wherein each of the lenses of the first lens group has a meniscus shape convex toward the object side on an optical axis,
wherein last n-th and n-1th lenses among the lenses of the second lens group have a meniscus shape convex toward the object side on the optical axis,
wherein the first lens group has a positive refractive power,
wherein the second lens group has a negative refractive power,
wherein a number of the lenses of the second lens group is greater than a number of the lenses of the first lens group,
wherein the following Equation satisfies:
$$40 < ( FOV * TTL ) / n < 150$$
(TTL is an optical axis distance from a center of an object-side surface of the first lens group to a surface of an image sensor, n is a total number of lenses, and FOV is field of view.), and
wherein a sum ΣCT of center thicknesses of the lenses of the first and second lens groups and sum ΣCG of distances between two adjacent lenses are satisfy the following equation:
$$0 < \sum CT / \sum CG < 1.$$

36. The optical system of claim 35, wherein effective diameters of the lenses of the first lens group gradually decreases from the object side toward the sensor side, and
wherein effective diameters of the lenses of the second lens group gradually increase from a lens surface closest to the first lens group toward the image sensor.

37. The optical system of claim 34, wherein a focal length of the first lens group is F13,
wherein a focal length of the second lens group is F48, and
wherein the following equations satisfies:
$$1 < \vert F 48 / F 13 \vert < 4 ( where F 48 < 0 ) .$$

38. The optical system of claim 35, wherein the first lens group includes first to third lenses,
wherein the second lens group includes fourth to eighth lenses,
wherein the aperture stop is disposed around an object-side surface of the second lens, and
wherein the following equation satisfies:
$$CT 6 + CT 7 + CT 8 < CG 7$$
(CT6 is a center thickness of the sixth lens, CT7 is a center thickness of the seventh lens, CT8 is a center thickness of the eighth lens, and CG7 is a center distance between the seventh and eighth lenses.).

39. The optical system of claim 38, wherein an object-side surface and the sensor-side surface of the seventh lens have a critical point, and
wherein an object-side surface and the sensor-side surface of the eighth lens have a critical point.

40. The optical system of claim 38, wherein a difference between an angle between the optical axis and a normal line perpendicular to a tangent line passing through an arbitrary point of the object-side surface of the seventh lens and an angle between the optical axis and a normal line perpendicular to a tangent line passing through an arbitrary point of the object-side surface of the eighth lens is less than 10 degrees.

41. The optical system of claim 38, wherein a difference between an angle between the optical axis and a normal line perpendicular to a tangent line passing through an arbitrary point of the sensor-side surface of the seventh lens and an angle between the optical axis and a normal line perpendicular to a tangent line passing through an arbitrary point of the sensor-side surface of the eighth lens is less than 10 degrees.

42. The optical system of claim 38, wherein the following equation satisfies:
$$1 \; 00 < \vert L 5 R 2 / CT 5 \vert < 300$$
(L5R2 is a curvature radius of the fifth lens on the optical axis, and CT5 is a center thickness of the fifth lens.).

43. The optical system of claim 38, wherein the following equations satisfy:
$$0 < CT 6 / CG 7 < 2$$
$$2 < CG 6 / CT 6 < 9$$
$$1 < CG 7 / CT 7 < 5$$
(CT6 is the center thickness of the sixth lens, CT7 is the center thickness of the seventh lens, CG6 is a center distance between the sixth and seventh lenses, and CG7 is the center distance between the seventh and eighth lenses.).

44. An optical system comprising:
a first lens group having a plurality of lenses whose effective radius gradually decreases from an object side to a sensor side;
a second lens group disposed on the sensor side of the first lens group and having a plurality of lenses having an effective radius gradually increasing from a lens closer to the first lens group toward the sensor side; and
an aperture stop disposed around an object-side surface of any one of the lenses of the first lens group,
wherein a quadratic function approximating a curve passing from an end of an effective region of a lens closest to the object side to an end of an effective region of a last lens closest to a image sensor satisfies the following function:
$$1 y = 0.042 x 2 - 0.4459 x + k 1$$
(k1 is a coefficient for setting the position in y-axis direction and satisfies 2.7±0.2.).
